(19) United States
(12) Patent Application Publication
(10) Pub. No.: US 2026/0047568 A1
(43) Pub. Date: Feb. 19, 2026

(54) AGRICULTURAL SPRAY SYSTEM HAVING SPATIALLY ALIGNED NOZZLE SETS

(71) Applicant: Centure Applications LTD, Tel Aviv-Yafo (IL)

(72) Inventors: Itzhak Khait, Vaughan (CA); Alon Klein Orbach, Tel Aviv (IL); Amir Berger, Kiryat Bialik (IL)

(21) Appl. No.: 19/087,100

(22) Filed: Mar. 21, 2025

Related U.S. Application Data
(60) Provisional application No. 63/684,542, filed on Aug. 19, 2024.
(60) Provisional application No. 63/750,943, filed on Jan. 29, 2025.

(51) Int. Cl. A01M 7/00

(52) U.S. Cl. CPC A01M 7/0089; A01M 7/0042; A01M 7/0071

(57) ABSTRACT

A spray system includes a spray boom attached to an agricultural vehicle. The spray boom including image sensors, first spray nozzles, and second spray nozzles. The first spray nozzles are fluidly coupled to a first fluid line that holds a first herbicide mixture that includes at least one residual herbicide. The second spray nozzles are fluidly coupled to a second fluid line that holds a second herbicide mixture that includes the at one residual herbicide and at least one non-residual herbicide. The spray areas of the first and second spray nozzles are at least partially spatially aligned with one another. Agricultural field regions where weeds are not detected are exclusively sprayed with the first herbicide mixture. Agricultural field regions where weeds are detected are exclusively sprayed with the second herbicide mixture.

### CROSS-REFERENCE TO RELATED APPLICATIONS

This application claims priority to U.S. Provisional Application No. 63/684,542, titled “Method For Application Of Herbicides Using Groups Of Broadcast And Selective-Spot Spray Nozzles,” filed on Aug. 19, 2024, and to U.S. Provisional Application No. 63/750,943, titled “Agricultural Spray Boom Having Groups Of Broadcast And Selective-Spot Spray Nozzles,” filed on Jan. 29, 2025, which are hereby incorporated by reference.

### TECHNICAL FIELD

This application relates generally to agricultural spray systems.

### BACKGROUND

Agricultural spray systems include spray booms with nozzles to spray an agricultural field. The nozzles include broadcast nozzles that apply a general-application agricultural product to all areas of the agricultural field and selective spot spray nozzles that apply a specific agricultural product where weeds are detected.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages, and novel features of the disclosure will be set forth in the following detailed description of the disclosure when considered in conjunction with the drawings, which are intended to illustrate, not limit, the invention.

An aspect of the invention is directed to a system for selectively spraying an agricultural field, the system comprising: (a) a tank containing an herbicidal mixture; (b) a first valve system fluidly connected to the tank, the first valve system including a plurality of first nozzles, each first nozzle configured to spray the herbicidal mixture onto at least one coverage area of the agricultural field such that the plurality of first nozzles is configured to spray the herbicidal mixture onto a set of coverage areas; (c) a direct injection system; (d) a second valve system fluidly connected to the tank and to the direct injection system, the second valve system including a plurality of second nozzles, each second nozzle configured to spray a mixture comprising the herbicidal mixture from the tank and at least one additional material injected by the direct injection system, wherein the plurality of second nozzles collectively covers substantially the same set of coverage areas as the plurality of first nozzles such that each coverage area can be sprayed by at least one of the first nozzles or at least one of the second nozzles; (e) at least one sensor configured to detect, for each coverage area, a presence or absence of one or more weeds; and (f) a controller operably coupled to the at least one sensor and configured to: (i) open at least one second nozzle in the second valve system for a given coverage area when the at least one sensor detects at least one weed in that coverage area or provides an inconclusive indication; and (ii) open at least one first nozzle in the first valve system for the given coverage area when the at least one sensor does not detect any weed in that coverage area, wherein each coverage area is sprayed only by one or more first nozzles from the first valve system or by one or more second nozzles from the second valve system, depending on the at least one sensor output for that coverage area.

In one or more embodiments, the at least one additional material injected by the direct injection system comprises at least one non-residual herbicide. In one or more embodiments, the herbicidal mixture in the tank comprises at least one non-residual herbicide.

In one or more embodiments, the at least one sensor comprises a machine-learning-based weed detection device configured to distinguish target weeds from background crops and/or soil. In one or more embodiments, the machine-learning-based weed detection device was trained using images that contain examples of target weeds and images that do not contain the target weeds.

In one or more embodiments, each coverage area is covered by exactly one first nozzle from the first valve system and exactly one second nozzle from the second valve system. In one or more embodiments, the inconclusive indication is triggered by at least one of: (i) a height of the first spray nozzles and/or a height of the second spray nozzles is/are outside of a respective predetermined height range for operation, (ii) one or more environmental factors preventing accurate weed detection, (iii) insufficient illumination conditions for the at least one sensor, and/or (iv) a malfunction and/or a communication failure of the at least one sensor.

Another aspect of the invention is directed to a method for spraying an agricultural field, comprising: in a spray system that includes a spray boom attached to an agricultural vehicle, the spray boom including a plurality of image sensors, a plurality of first spray nozzles, and a plurality of second spray nozzles, the first spray nozzles fluidly coupled to a first fluid line that holds a first herbicide mixture that includes at least one residual herbicide, the second spray nozzles fluidly coupled to a second fluid line that holds a second herbicide mixture that includes the at least one residual herbicide and at least one non-residual herbicide, the first and second spray nozzles arranged in a plurality of nozzle groups, each nozzle group including at least one first spray nozzle and at least one second spray nozzle, the at least one first spray nozzle and the at least one second spray nozzle in a respective nozzle group having respective spray areas that are spatially aligned with one another, each nozzle group associated with a respective image sensor: automatically capturing, with each image sensor, images of an agricultural field, each image sensor associated with a respective nozzle group; automatically analyzing, with one or more computers, each image for a presence of at least one target weed; automatically detecting, with the one or more computers, the at least one target weed in one or more image areas of one or more of the images to provide at least one weed-detected image having at least one weed-detected image area in which the at least one target weed is detected and at least one weed-absent image area in which the at least one target weed is not detected; automatically exclusively spraying the first herbicide mixture onto one or more first regions of the agricultural field, each first region corresponding to a respective weed-absent image area; automatically exclusively spraying the second herbicide mixture onto one or more second regions of the agricultural field, each second region corresponding to a respective weed-detected image area, whereby the first herbicide mixture is only sprayed onto the one or more first regions and the second herbicide mixture is only sprayed onto the one or more second regions.

In one or more embodiments, each first region of the agricultural field is sprayed by a respective first spray nozzle having a respective first spray area spatially aligned with a respective first region, and each second region of the agricultural field is sprayed by a respective second spray nozzle having a respective second spray area spatially aligned with a respective second region. In one or more embodiments, the image sensors comprise cameras, and the method further comprises: automatically analyzing, with a respective trained machine learning (ML) model running on a respective computer, a respective image for the presence of the at least one target weed, the trained ML model having been trained with first images that include the at least one target weed and second images that do not include the at least one target weed; and automatically detecting, with the respective trained ML model, the at least one target weed in the one or more image areas of the one or more of the images. In one or more embodiments, each camera has a respective field of view (FOV) that is subdivided into a plurality of FOV regions, each FOV region associated with a respective first spray nozzle of the respective nozzle group and a respective second spray nozzle of the respective nozzle group, each image area corresponds to a respective FOV area, each first region of the agricultural field is sprayed by the respective first spray nozzle that corresponds to the respective FOV area for a respective weed-absent image area, and each second region of the agricultural field is sprayed by the respective second spray nozzle that corresponds to the respective FOV area for a respective weed-detected image area.

Another aspect of the invention is directed to a spray boom comprising: a plurality of image sensors mounted on the spray boom, each image sensors configured to capture a respective image of a respective region of an agricultural field; a plurality of first spray nozzles mounted on the spray boom, the first spray nozzles fluidly coupled to a first fluid line that holds a first herbicide mixture that includes at one residual herbicide; a plurality of second spray nozzles mounted on the spray boom, the second spray nozzles fluidly coupled to a second fluid line that holds a second herbicide mixture that includes the at one residual herbicide and at least one non-residual herbicide, the first and second spray nozzles arranged in a plurality of nozzle groups, each nozzle group including at least one first spray nozzle and at least one second spray nozzle, the at least one first spray nozzle and the at least one second spray nozzle in a respective nozzle group having respective spray areas that are spatially aligned with one another, each nozzle group associated with a respective image sensor; and one or more processors configured to: automatically analyze each image for a presence of at least one target weed; automatically detecting the at least one target weed in one or more image areas of one or more of the images to provide at least one weed-detected image having at least one weed-detected image area in which the at least one target weed is detected and at least one weed-absent image area in which the at least one target weed is not detected; for each weed-absent image area of a respective weed-detected image, cause only a respective first spray nozzle to spray the first herbicidal mixture onto a respective first target area that corresponds to a respective weed-absent image area, the respective first nozzle in the respective nozzle group associated with the respective image sensor that captured the respective weed-detected image, such that each first target area is sprayed exclusively with the first herbicidal mixture; and for each weed-detected image area of the respective weed-detected image, cause only a respective second spray nozzle to spray the second herbicidal mixture onto a respective second target area that corresponds to a respective weed-detected image area, the respective second nozzle in the respective nozzle group associated with the respective image sensor that captured the respective weed-detected image, such that each second target area is sprayed exclusively with the second herbicidal mixture.

In one or more embodiments, the image sensors comprise cameras, and the one or more processors is/are further configured to: automatically analyze, with one or more trained machine learning (ML) models, each image for the presence of the at least one target weed, the trained ML model(s) having been trained with first images that include the at least one target weed and second images that do not include the at least one target weed; and automatically detect, with the trained ML model(s), the at least one target weed in the one or more image areas of the one or more of the images. In one or more embodiments, each camera has a respective field of view (FOV) that is subdivided into a plurality of FOV regions, each FOV region associated with a respective first spray nozzle of the respective nozzle group and a respective second spray nozzle of the respective nozzle group, each image area corresponds to a respective FOV area, each first target area is sprayed by the respective first spray nozzle that corresponds to the respective FOV area for a respective weed-absent image area, and each second target area is sprayed by the respective second spray nozzle that corresponds to the respective FOV area for a respective weed-detected image area.

In one or more embodiments, the at least one target weed is not detected in on or more images to provide at least one weed-absent image, each weed-absent image having a plurality of the weed-absent image areas, and the one or more processors is/are further configured to, for each weed-absent image area of a respective weed-absent image, cause only the respective first spray nozzle to spray the first herbicidal mixture onto the respective first target area that corresponds to the respective weed-absent image area, the respective first nozzle in the respective nozzle group associated with the respective image sensor that captured the respective weed-detected image.

In one or more embodiments, the spray boom further comprises a plurality of first valves fluidly coupled to the first fluid line, each first valve fluidly coupled to a respective first spray nozzle; a plurality of second valves fluidly coupled to the second fluid line, each second valve fluidly coupled to a respective second spray nozzle, wherein the one or more processors is/are further configured to: for each weed-absent image area of the respective weed-detected image, cause only a respective first valve to open, the respective first valve fluidly coupled to the respective first spray nozzle that sprays the respective first target area that corresponds to the respective weed-absent image area, the respective first nozzle in the respective nozzle group associated with the respective image sensor that captured the respective weed-detected image; and for each weed-detected image area of the respective weed-detected image, cause only a respective second valve to open, the respective second valve fluidly coupled to the respective second spray nozzle that sprays the respective second target area that corresponds to the respective weed-detected image area, the respective second nozzle in the respective nozzle group associated with the respective image sensor that captured the respective weed-detected image.

In one or more embodiments, the one or more processors is/are further configured to: for each weed-detected image area of the respective weed-detected image, cause the respective first valve to close, the respective first valve fluidly coupled to the respective first spray nozzle having a respective first target spray area that is spatially aligned with the respective second target area; and for each weed-absent image area of the respective weed-detected image, cause the respective second valve to close, the respective second valve fluidly coupled to the respective second spray nozzle having a respective second target spray area that is spatially aligned with the respective first target area.

In one or more embodiments, each nozzle group includes a plurality of nozzle pairs, each nozzle pair including only one respective first spray nozzle and only one respective second spray nozzle, the first and second spray nozzles in a respective nozzle pair having respective spray areas that are spatially aligned with one another. In one or more embodiments, each nozzle group includes a plurality of nozzle sub-groups, each nozzle sub-group including one or more of the respective first spray nozzles and one or more of the respective second spray nozzles, the one or more first spray nozzles and the one or more second spray nozzles in a respective nozzle sub-group having respective spray areas that are at least partially spatially aligned with one another. In one or more embodiments, each nozzle sub-group includes more of the respective second spray nozzles than the respective first spray nozzles.

Another aspect of the invention is directed to an agricultural spray system comprising an agricultural vehicle; and the spray boom, the spray boom attached to the agricultural vehicle; a first tank on the agricultural vehicle, the first spray tank holding the first herbicide mixture, the first tank fluidly coupled to the first fluid line; and a second tank on the agricultural vehicle, the second tank capable of holding the second herbicidal mixture, the second tank fluidly coupled to the second fluid line.

Another aspect of the invention is directed to an agricultural spray system comprising an agricultural vehicle; and the spray boom, the spray boom attached to the agricultural vehicle; a residual herbicide tank on the agricultural vehicle, the residual herbicide tank holding the at least one residual herbicide, the residual herbicide tank fluidly coupled to the first fluid line; a reservoir tank on the agricultural vehicle, the reservoir tank having a first input fluidly coupled to the residual herbicide tank to receive the at least one residual herbicide; a container configured to hold the at least one non-residual herbicide, the container on the agricultural vehicle; and a direct injection system fluidly coupled to the container and to a second input of the reservoir tank, the direct injection system configured to introduce the at least one non-residual herbicide into the reservoir tank to produce the second herbicidal mixture, the reservoir tank having an output fluidly coupled to the second fluid line.

Another aspect of the invention is directed to an agricultural spray system comprising an agricultural vehicle; and the spray boom, the spray boom attached to the agricultural vehicle; a water tank on the agricultural vehicle; a first container configured to hold the at least one residual herbicide, the first container on the agricultural vehicle; a second container configured to hold the at least one non-residual herbicide, the second container on the agricultural vehicle; a first reservoir tank on the agricultural vehicle, the first reservoir tank having a first input fluidly coupled to the water tank and a first output fluidly coupled to the first fluid line; a second reservoir tank on the agricultural vehicle, the second reservoir tank having a first input fluidly coupled to the water tank, a second input fluidly coupled to a second output of the first reservoir tank, and an output fluidly coupled to the second fluid line; a first direct injection system having a first input fluidly coupled to the first container and an output fluidly coupled to a second input of the first reservoir tank, the first direct injection system configured to introduce the at least one residual herbicide into the first reservoir tank to produce the first residual herbicide mixture; and a second direct injection system having a first input fluidly coupled to the second container and an output fluidly coupled to a third input of the second reservoir tank, the second direct injection system configured to introduce the at least one non-residual herbicide into the second reservoir tank to form the second herbicidal mixture that comprises the first residual herbicide mixture and the least one non-residual herbicide.

Another aspect of the invention is directed to an agricultural spray system comprising an agricultural vehicle; and the spray boom, the spray boom attached to the agricultural vehicle; a water tank on the agricultural vehicle; a first container configured to hold the at least one residual herbicide, the first container on the agricultural vehicle; a second container configured to hold the at least one non-residual herbicide, the second container on the agricultural vehicle; a first reservoir tank on the agricultural vehicle and having a first input fluidly coupled to the water tank and a first output fluidly coupled to the first fluid line; a second reservoir tank on the agricultural vehicle, the second reservoir tank having a first input fluidly coupled to a second output of the first reservoir tank and an output fluidly coupled to the second fluid line; a first direct injection system having a first input fluidly coupled to the first container and an output fluidly coupled to a second input of the first reservoir tank, the first direct injection system configured to introduce the at least one residual herbicide into the reservoir tank to produce the first herbicide mixture; and a second direct injection system having a first input fluidly coupled to the second container and an output fluidly coupled to a third input of the second reservoir tank, the second direct injection system configured to introduce the at least one non-residual herbicide into the second reservoir tank to form the second herbicidal mixture that comprises the first herbicide mixture and the at least one non-residual herbicide.

Another aspect of the invention is directed to an agricultural spray system comprising an agricultural vehicle; and the spray boom, the spray boom attached to the agricultural vehicle; a water tank on the agricultural vehicle; a first container configured to hold the at least one residual herbicide, the first container on the agricultural vehicle; a second container configured to hold the at least one residual herbicide and the at least one non-residual herbicide, the second container on the agricultural vehicle; a first reservoir tank on the agricultural vehicle and having a first input fluidly coupled to the water tank and an output fluidly coupled to the first fluid line; a second reservoir tank on the agricultural vehicle, the second reservoir tank having a first input fluidly coupled to the water tank and an output fluidly coupled to the second fluid line; a first direct injection system having a first input fluidly coupled to the first container and an output fluidly coupled to a second input of the first reservoir tank, the first direct injection system configured to introduce the at least one residual herbicide into the reservoir tank to produce the first herbicide mixture; and a second direct injection system having a first input fluidly coupled to the second container and an output fluidly coupled to a second input of the second reservoir tank, the second direct injection system configured to introduce the at least one residual herbicide and the at least one non-residual herbicide into the second reservoir tank to form the second herbicidal mixture.

Another aspect of the invention is directed to an agricultural spray system comprising: an agricultural vehicle; a spray boom attached to the agricultural vehicle; a plurality of cameras mounted on the spray boom, each camera configured to capture a respective image of a respective region of an agricultural field; a plurality of broadcast nozzles mounted on the spray boom, the broadcast nozzles fluidly coupled to a broadcast fluid line; a plurality of selective-spot spray (SSP) nozzles mounted on the spray boom, the SSP nozzles fluidly coupled to an SSP fluid line; a water tank on the agricultural vehicle; one or more first containers, each first container configured to hold a respective residual herbicide, each first container on the agricultural vehicle; one or more second containers, each second container configured to hold a respective non-residual herbicide, each second container on the agricultural vehicle; a first fluid line fluidly coupled to the water tank; a second fluid line fluidly coupled to the water tank; one or more first direct injection systems, each first direct injection system having a respective first input fluidly coupled to a respective first container and a respective output fluidly coupled to the first fluid line, each first direct injection system configured to introduce the respective residual herbicide into the first fluid line; one or more second direct injection systems, each second direct injection system having a respective first input fluidly coupled to a respective second container and a respective output fluidly coupled to the second fluid line, each second direct injection system configured to introduce the respective residual herbicide into the second fluid line; a first in-line mixer fluidly coupled to the first fluid line and configured to mix each residual herbicide and water from the water tank to form a residual herbicide mixture; a second in-line mixer fluidly coupled to the second fluid line and configured to mix each non-residual herbicide and the water to form a non-residual herbicide mixture; and a mixing tank configured to hold a volume of the non-residual herbicide mixture, the mixing tank having an input fluidly coupled to an output of the second mixing tank, the mixing tank having an output fluidly coupled to the SSP nozzles.

In one or more embodiments, the agricultural spray system further comprises one or more processors configured to: automatically analyze, with a trained machine learning (ML) model, each image for a presence of at least one target weed, the trained ML model having been trained with first images that include the at least one target weed and second images that do not include the at least one target weed; automatically detect, with the trained ML model, the at least one target weed in one or more image areas of one or more of the images to provide at least one weed-detected image having at least one weed-detected image area in which the at least one target weed is detected and at least one weed-absent image area in which the at least one target weed is not detected; for each weed-detected image area of a respective weed-detected image, automatically cause a respective SSP nozzle to selectively spot spray the non-residual herbicide mixture onto a respective first target area that corresponds to a respective weed-detected image area; and automatically cause the broadcast nozzles to broadcast spray the residual herbicide mixture substantially continuously onto the agricultural field.

Another aspect of the invention is directed to an agricultural spray system comprising: an agricultural vehicle; a water tank on the agricultural vehicle; a first fluid line fluidly coupled to the water tank; a second fluid line fluidly coupled to the water tank; a first direct injection system fluidly coupled to at least one container configured to hold a first herbicide, the first direct injection system configured to introduce the first herbicide into the first fluid line; a second direct injection system fluidly coupled to at least one container configured to hold a second herbicide, the second direct injection system configured to introduce the second herbicide into the second fluid line; at least one sensor mounted on the agricultural vehicle and configured to detect a presence or absence of weeds in a particular area of a field; and at least one valve operably connected to the at least one sensor, the at least one sensor being configured to send a command to the at least one valve to selectively spray or not spray the particular area using the first fluid line and/or the second fluid line.

In one or more embodiments, the first herbicide comprises at least one residual herbicide and the second herbicide comprises at least one non-residual herbicide. In one or more embodiments, one of the fluid lines is configured to spray in a broadcast mode, and the other fluid line is configured to refrain from spraying in areas where no weeds are detected.

In one or more embodiments, the first fluid line containing the at least one residual herbicide is configured to spray in a broadcast mode, and the second fluid line containing the at least one non-residual herbicide is configured to spray upon detection of at least one of the weeds in the particular area of the field or upon occurrence of at least one of the following conditions: (i) a height of the at least one valve is/are outside of a respective predetermined height range for operation, (ii) one or more environmental factors prevent accurate weed detection, (iii) insufficient illumination conditions for the at least one sensor, and/or (iv) a malfunction and/or a communication failure of the at least one sensor.

In one or more embodiments, the agricultural spray system further comprises a buffer tank having an input fluidly coupled to the second fluid line, the buffer tank configured to hold a volume of an herbicide mixture that includes water and the second herbicide, the buffer tank having an output fluidly coupled to the at least one valve, such that the at least one valve can selectively spray using the second fluid line when a flow rate of the second fluid line is variable.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is an isometric view of an agricultural spray system according to one or more embodiments.

FIG. 2 is a side view of an agricultural spray system according to one or more embodiments.

FIG. 3 is a block diagram of an agricultural system for selectively applying a treatment to a target region according to one or more embodiments.

FIG. 4 is a simplified block diagram of an agricultural spray boom according to one or more embodiments.

FIG. 5 is an isolated block diagram showing the spray areas of the broadcast and selective-spot spray (SSP) nozzles of the first nozzle group on the agricultural spray boom shown in FIG. 4 according to one or more embodiments.

FIG. 6A is an isolated block diagram showing the spray areas of the broadcast and SSP nozzles of the first nozzle group on the agricultural spray boom shown in FIG. 4 in a first configuration.

FIG. 6B is an isolated block diagram showing the spray areas of the broadcast and SSP nozzles of the first nozzle group on the agricultural spray boom shown in FIG. 4 in a second configuration.

FIG. 7 is a block diagram of the spray boom shown in FIG. 4 passing over an agricultural field.

FIG. 8 is a simplified block diagram of an agricultural spray boom according to one or more embodiments.

FIG. 9 shows the spray areas of the broadcast and SSP nozzles on the agricultural spray boom shown in FIG. 8 according to one or more embodiments.

FIG. 10 is a block diagram of the spray boom shown in FIG. 8 passing over an agricultural field.

FIG. 11 is a simplified block diagram of an agricultural spray boom according to one or more embodiments.

FIG. 12 shows the spray areas of the broadcast and SSP nozzles on the agricultural spray boom shown in FIG. 11 according to one or more embodiments.

FIG. 13 is a block diagram of the spray boom shown in FIG. 11 passing over an agricultural field.

FIG. 14 is a simplified block diagram of an agricultural spray boom according to one or more embodiments.

FIG. 15 shows the spray areas of the broadcast and SSP nozzles on the agricultural spray boom shown in FIG. 14 according to one or more embodiments.

FIG. 16 is a simplified block diagram of an agricultural spray boom according to one or more embodiments.

FIG. 17 shows the spray areas of the broadcast and SSP nozzles on the agricultural spray boom shown in FIG. 16 according to one or more embodiments.

FIG. 18 is a flow chart of a method for spraying an agricultural field according to one or more embodiments.

FIG. 19 is a simplified block diagram of fluid and electrical circuits for an agricultural spray system according to one or more embodiments.

FIG. 20 is a detailed block diagram of the fluid and electrical circuits shown in FIG. 19 according to one or more embodiments.

FIG. 21 is a detailed block diagram of the fluid and electrical circuits shown in FIG. 19 according to one or more alternative embodiments.

FIG. 22 is a flow chart of a method for controlling the fluid circuits for an agricultural spray system that includes a direct-injection system.

FIGS. 23-27 are detailed block diagrams of the fluid and electrical circuits shown in FIG. 19 according to one or more alternative embodiments.

FIG. 28 is a simplified block diagram of fluid and electrical circuits for an agricultural spray system according to one or more alternative embodiments.

FIG. 29 is a simplified block diagram of fluid and electrical circuits for an agricultural spray system according to one or more alternative embodiments.

FIG. 30 is a simplified block diagram of fluid and electrical circuits for an agricultural spray system according to one or more alternative embodiments.

FIG. 31 is a simplified illustration of a drone flying over an agricultural field.

FIG. 32 is a simplified block diagram of fluid and electrical circuits for an agricultural spray system according to one or more alternative embodiments.

FIG. 33 shows an agricultural sprayer system according to one or more embodiments.

FIG. 34 is a block diagram of a system for selectively spraying an agricultural field according to one or more embodiments.

### DETAILED DESCRIPTION

A system for selectively spraying an agricultural field includes a first valve system having a plurality of first nozzles, each first nozzle configured to spray at least one coverage area of the agricultural field such that the plurality of first nozzles is configured to spray a set of coverage areas. The system further includes a second valve system having a plurality of second nozzles, each first nozzle configured to spray the at least one coverage area of the agricultural field such that the first and second nozzles are configured to spray the same or substantially the same set of coverage areas. The first nozzles can spray one or more residual herbicides. The second nozzles can spray a mixture of one or more residual herbicides and one or more non-residual herbicides.

One or more sensors can be configured to detect weeds in each coverage area. When one or more weeds is/are detected in a given coverage area, a controller can cause one or more second nozzles is/are activated to spray that coverage area with one or more residual herbicides. When no weeds is/are detected in a given coverage area, the controller can cause one or more first nozzles is/are activated to spray that coverage area with the mixture of one or more residual herbicides and one or more non-residual herbicides. Thus, each coverage area can be sprayed exclusively by one or more first nozzles or by one or more second nozzles depending on whether the at least one sensor detects any weeds in that coverage area.

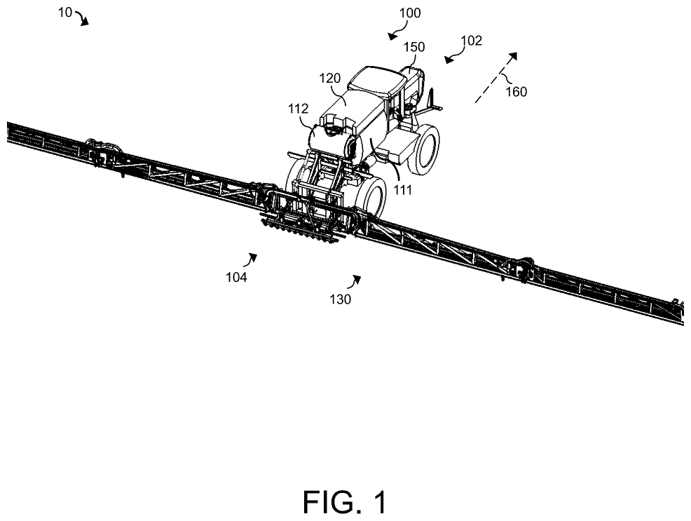

FIG. 1 is an isometric view of an agricultural spray system 10 according to one or more embodiments. The system 10 includes an agricultural vehicle 100, an optional first tank 111, an optional second tank 112, a rinse/water tank 120, and a spray boom 130.

The optional first tank 111 is mounted on the agricultural vehicle 100 and is configured to hold one or more general-application herbicides (e.g., one or more residual herbicides that persist in the soil for an extended period, controlling weeds that germinate after application) to be selectively sprayed onto an agricultural field using first spray nozzles on the spray boom 130, which is attached to the agricultural vehicle 100. Examples of residual herbicides include s-metolachlor, acetochlor, pyroxasulfone, atrazine and/or mesotrione. One or more first fluid lines fluidly couple the first tank 111 to one or more first spray nozzles on the spray boom 130. In one or more alternative embodiments, the first fluid line(s) can be fluidly coupled to the rinse/water tank 120 and to a first direct-injection system that injects residual herbicides into the first fluid line(s) to create a residual-herbicide/water mixture (e.g., a first herbicide mixture) having a target concentration of residual herbicides.

Valve(s) coupled to the first spray nozzle(s) can be opened and closed at a frequency and at a variable duty cycle to control the application rate (typically measured in gallons per acre (GPA)) of the general-application liquid agricultural product(s)). The duty cycle can be varied according to the speed of the agricultural vehicle 100, the height of the spray boom 130, and/or in response to imaging and/or sensing of the agricultural field and analysis/detection of target features such as weeds (or the failure to detect weeds). The weeds can be sensed using one or more sensors such as light sensors (e.g., near-infrared light sensor(s), fluorescent sensor(s), cameras, and/or other light sensor(s)). A computer can detect weeds by comparing the sensed (e.g., reflected) light, such as red, blue, and/or near-infrared light, to a predetermined threshold. Additionally or alternatively, weeds can be detected by feeding the output of the light sensors to one or more trained machine learning models. The broadcast nozzle(s) and respective valves can be controlled individually and/or in groups/sectors.

An optional second tank 112 is mounted on the agricultural vehicle 100 and is configured to hold a second herbicide mixture that includes one or more non-residual herbicides that target one or more weeds growing and/or one or more pests and/or fungi in the agricultural field (in general, one or more target features in the agricultural field) and one or more residual herbicides. The residual herbicide(s) in the second herbicide mixture can be the same as the residual herbicide(s) in the first tank 111 or in the first herbicide mixture. Examples of non-residual herbicides include glyphosate, glufosinate, and/or 2,4-dichlorophenoxyacetic acid (commonly referred to as 2,4-D). One or more second fluid lines can fluidly couple the second tank 112 to one or more second spray nozzles on the spray boom 130. In one or more alternative embodiments, the second fluid line(s) can be fluidly coupled to the first tank 111 and to a second direct-injection system that injects non-residual herbicides into the second fluid line(s) to create a mixture of residual and non-residual herbicides (e.g., a second herbicide mixture). In one or more alternative embodiments, the second fluid line(s) can be fluidly coupled to the rinse/water tank 120 and to a first direct-injection system that injects one or more residual herbicides into the second fluid line(s) and to second direct-injection system that injects one or more non-residual herbicides into the second fluid line(s) to create the second herbicide mixture.

The second herbicide mixture is selectively sprayed using the second nozzle(s) in response to light sensing and/or imaging of the agricultural field and analysis/detection of weeds and/or target features. Valve(s) coupled to the second nozzle(s) can be opened and closed to selectively spray the detected weeds. When the valve(s) is/are opened, the valve(s) can be repeatedly opened and closed at a frequency and at a variable duty cycle. The duty cycle can be varied according to the speed of the agricultural vehicle 100 and/or the height of the spray boom 130 to maintain a uniform or substantially uniform (e.g., within about 5% to about 10%) application rate of the second herbicide mixture.

The rinse tank 120 can be fluidly coupled to the optional first tank 111 and/or to the optional second tank 112. Water and/or another liquid stored in the rinse tank 120 can be used to rinse the first tank 111 and/or the second tank 112 after each tank 111, 112 is emptied. The rinse tank 120 can be optional in some embodiments. In one or more alternative embodiments, the rinse tank 120 can be fluidly coupled to the first fluid line(s) and/or to the second fluid line(s), for example to one or more direct-injection systems.

The engine 150 for the agricultural vehicle 100 can be replaced with a motor when the agricultural vehicle 100 is electric or can include both an engine and a motor when the agricultural vehicle 100 is a hybrid vehicle. In any case, the agricultural vehicle 100 includes a mechanical drive system that powers the agricultural vehicle 100 and the wheels.

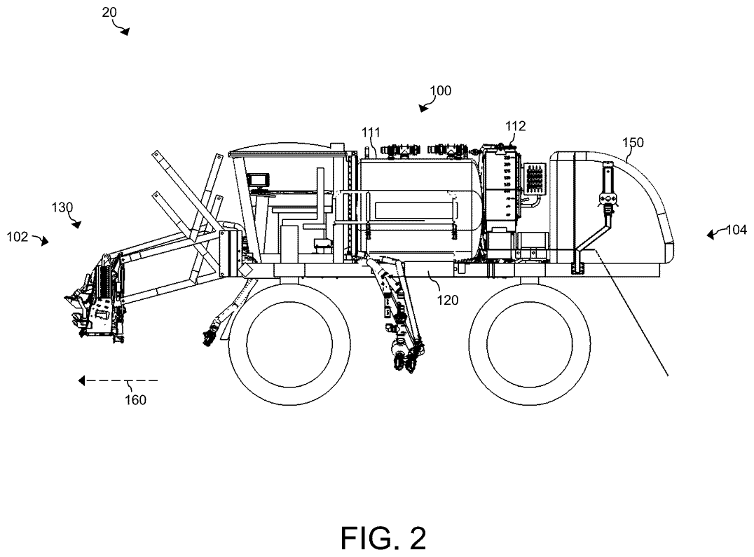

The spray boom 130 is attached to the back 104 of the agricultural vehicle 100 in a first configuration such that the agricultural vehicle 100 pulls the spray boom 130 as the agricultural vehicle 100 drives forward (e.g., in direction 160), as illustrated in FIG. 1. In a second configuration, the spray boom 130 can be attached to the front 102 of the agricultural vehicle 100 such that the agricultural vehicle 100 pushes the spray boom 130 as the agricultural vehicle 100 drives forward. An example of the second configuration is illustrated in FIG. 2, which is a side view of a dual-sprayer agricultural spray system 20 according to another embodiment. System 20 is the same as system 10 except for the locations of the optional broadcast tank 111, the optional SSP tank 112, and the optional rinse tank 120 and for the configuration/location of the spray boom 130.

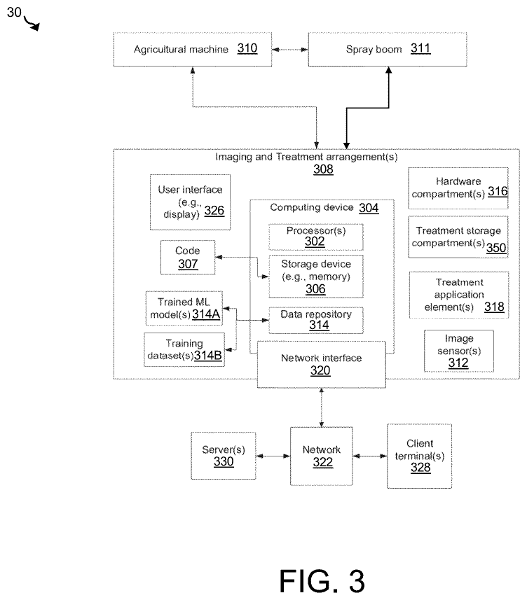

FIG. 3 is a block diagram of an agricultural spray system 30 for selectively applying a treatment to a target region according to one or more embodiments. System 30 can be the same as system 10 and/or system 20.

System 30 includes one or more imaging and treatment arrangements 308 connected to and/or mounted on an agricultural machine 310, for example, a tractor, an airplane, an off-road vehicle, or a drone. Alternatively, the imaging and treatment arrangement(s) 308 can be connected to and/or mounted on a spray boom 311, which can be the same as spray boom 130. The agricultural machine 310 can include and/or can be connected to the spray boom 311. Agricultural machine 310 can be the same as agricultural machine 100. Imaging and treatment arrangements 308 may be arranged along a length of the agricultural machine 310 and/or of the spray boom 311. For example, the imaging and treatment arrangements 308 can be evenly spaced every 1-3 meters along the length of spray boom 311. Spray boom 311 may be long, for example, 10-50 meters, or another length. Spray boom 311 may be pushed or pulled by agricultural machine 310. In another embodiment, the system 30 only includes one imaging and treatment arrangement 308.

An example imaging and treatment arrangement 308 is depicted for clarity, but it is to be understood that system 30 may include multiple imaging and treatment arrangements 308. It is noted that each imaging and treatment arrangement 308 may include all components described herein. Alternatively, one or more imaging and treatment arrangements 308 can share one or more components, for example, multiple imaging and treatment arrangements 308 can share a common computing device 304, common memory 306, and/or common processor(s) 302.

Each imaging and treatment arrangement 308 includes one or more image sensors 312 that acquire images of the agricultural field. Examples of an image sensor 312 include a color sensor, optionally a visible light-based sensor, for example, a red-green-blue (RGB) sensor such as CCD and/or CMOS sensors, and/or other cameras (e.g., cameras 640) and/or other sensors such as an infra-red (IR) sensor, a near-IR sensor, an ultraviolet sensor, a fluorescent sensor, a LIDAR sensor, an NDVI sensor, a two-dimensional sensor, a three-dimensional sensor, and/or a multispectral sensor. Image sensor(s) 312 is/are arranged and/or positioned to capture images of a portion of the agricultural field (e.g., located in front of image sensor(s) 312 and along a direction of motion of agricultural machine 310).

A computing device 304 receives the image(s) from the image sensor(s) 312, for example, via a direct connection (e.g., local bus and/or cable connection and/or short-range wireless connection), a wireless connection and/or via a network. The image(s) are processed by processor(s) 302, which feeds the image into a trained machine learning (ML) model 314A (e.g., trained on a training dataset(s) 314B that include training images of agricultural fields with one or more target features, such as target weeds, target pests/insects, target fungi and training images of agricultural fields without any target features). Training dataset(s) 314B are used to train an untrained ML model to create the trained ML model 314A and may not be included in system 30 in some embodiments.

The trained ML model 314A can be configured to detect a target feature, such as one or more weeds, one or more target pests/insects, and/or one or more target fungi, within the image(s), that is separate from a desired growth (e.g., a crop). Additionally or alternatively, the trained ML model 314A can be configured to detect one or more target agricultural crops. One treatment storage compartment 350 may be selected from multiple treatment storage compartments according to the outcome of trained ML model 314A, for administration of a treatment by one or more treatment application element(s) 318, as described herein. For example, a second herbicide mixture (e.g., from the optional second tank 112) can be selected to provide treatment in response to the detection of a target weed (and/or another target feature) and a first herbicide mixture (e.g., from the optional the optional first tank 111) can be selected to provide treatment for the other regions of the agricultural field (e.g., where target weed(s) and/or another target feature(s) is/are not detected).

Hardware processor(s) 302 of computing device 304 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 302 may include a single processor, or multiple processors (homogenous or heterogeneous) arranged for parallel processing, as clusters and/or as one or more multi core processing devices.

Storage device (e.g., memory) 306 stores code instructions executable by hardware processor(s) 302, for example, a random-access memory (RAM), read-only memory (ROM), and/or a storage device, for example, non-volatile memory, magnetic media, semiconductor memory devices, hard drive, removable storage, and optical media (e.g., DVD, CD-ROM). Memory 306 stores code 307 that implements one or more features and/or instructions to be executed by the hardware processor(s) 302. Memory 306 can comprise or consist of solid-state memory and/or a solid-state device.

Computing device 304 may include a data repository 314 (e.g., storage device(s)) for storing data, for example, trained ML model(s) 314A which may include a detector component and/or a classifier component. The data repository 314 also stores the captured real-time images taken with the respective image sensor 312. The data repository 314 may be implemented as, for example, a computer memory, a local hard-drive, a solid-state drive, a solid-state memory, virtual storage, a removable storage unit, an optical disk, a storage device, and/or as a remote server and/or computing cloud (e.g., accessed using a network connection). Additional details regarding the trained ML model(s) 314A, the training dataset(s) 314B, and/or other components of system 30 are described in U.S. Pat. No. 11,393,049, titled “Machine Learning Models For Selecting Treatments For Treating an Agricultural Field,”which is hereby incorporated by reference.

Computing device 304 is in communication with one or more treatment storage compartment(s) (e.g., tank(s)) 350 and/or treatment application elements 318 (e.g., including respective valves such as valves 431, 432) that apply treatment for treating the field and/or plants growing on the field. There may be two or more treatment storage compartment(s) 350, for example, one or more compartments (e.g., second tank 112) storing a second herbicide mixture that includes residual and non-residual herbicides, and another one or more compartments (e.g., first tank 111) storing a first herbicide mixture that only includes residual herbicides that are non-specific to target growths such as designed for different types of target features such as weeds, pests/insects, fungi, and/or for the prevention of such target features. One or more of the treatment storage compartment(s) 350 can comprise a portion of a direct-injection system. In an embodiment, the system 30 can include a first direct-injection system for the non-residual herbicides and/or one or more second direct-injection systems for the residual herbicides.

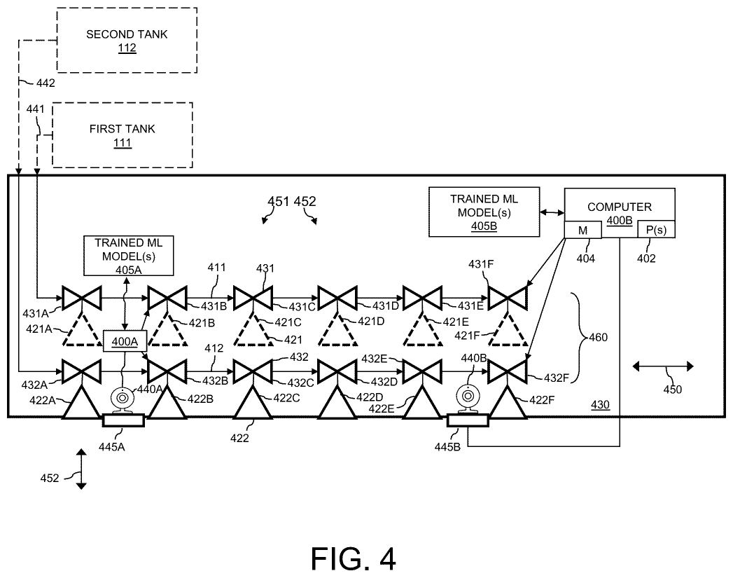

There may be one or multiple treatment application elements 318 connected to the treatment storage compartment(s) 350, for example, one or more first spray nozzles (e.g., first spray nozzles 421 (FIG. 4) connected to a first compartment (e.g., first tank 111) and one or more second spray nozzles (e.g., second spray nozzles 422 (FIG. 4)) connected to a second compartment (e.g., second tank 112). A respective valve (e.g., valve 431 or valve 432 (FIG. 4)) can be opened and closed to drive fluid through a respective first spray nozzle(s) 421 or a respective second spray nozzle(s) 422 (FIG. 4). The valves can be opened and closed at a frequency and at a variable duty cycle as described herein.

Computing device 304 and/or imaging and treatment arrangement 308 may include a network interface 320 for connecting to a network 322, for example, one or more of, a network interface card, an antenna, a wireless interface to connect to a wireless network, a physical interface for connecting to a cable for network connectivity, a virtual interface implemented in software, network communication software providing higher layers of network connectivity, and/or other implementations.

Computing device 304 and/or imaging and treatment arrangement 308 may communicate with one or more client terminals 328 (e.g., smartphones, mobile devices, laptops, smart watches, tablets, desktop computer) and/or with a server(s) 330 (e.g., web server, network node, cloud server, virtual server, virtual machine) over network 322. Client terminals 328 may be used, for example, to remotely monitor imaging and treatment arrangement(s) 308 and/or to remotely change parameters thereof. Server(s) 330 may be used, for example, to remotely collect data from multiple imaging and treatment arrangement(s) 308 optionally of different agricultural machines, for example, to create new training datasets and/or to update exiting training datasets for updating the trained ML model(s) 314A with new images.

Network 322 may be implemented as, for example, the internet, a local area network, a wire-area network, a virtual network, a wireless network, a cellular network, a local bus, a point-to-point link (e.g., wired), and/or combinations of the aforementioned.

Computing device 304 and/or imaging and treatment arrangement 308 includes and/or is in communication with one or more user interfaces 326 (e.g., physical and/or electronic user interface(s)) that include a mechanism for user interaction, for example, to enter data (e.g., define threshold and/or set of rules) and/or to view data (e.g., results of which treatment was applied to which portion of the field).

Example physical user interfaces 326 include, for example, a touchscreen, a display, gesture activation devices, a keyboard, a mouse, and/or voice-activated software using speakers and a microphone. Alternatively, client terminal 328 serves as the user interface by communicating with computing device 304 and/or server 330 over network 322.

Treatment application elements 318 may be adapted for selective spot spraying a first or second herbicide mixture, for example as described in U.S. Provisional Ser. No. 63/149,378, filed on Feb. 15, 2021, and/or in U.S. Pat. No. 11,393,049, which are hereby incorporated by reference.

System 30 may include a hardware component 316 associated with the agricultural machine 310 for dynamic adaption of the liquid agricultural products applied by the treatment application element(s) 318 according to dynamic orientation parameter(s) computed by analyzing an overlap region of images captured by image sensors 312, for example as described in U.S. Provisional Ser. No. 63/082,500 , filed on Sep. 24, 2020, and/or in U.S. Pat. No. 11,393,049, which are hereby incorporated by reference.

FIG. 4 is a simplified block diagram of an agricultural spray boom 430 according to one or more embodiments. The spray boom 430 can be the same as spray boom 130 and thus can be mounted or attached to an agricultural vehicle 100 to form a system 10, 20. Additionally or alternatively, the spray boom 430 can be the same as spray boom 311 and thus can be mounted or attached to an agricultural machine 310 to form a system 30. The spray boom 430 can be manufactured and/or sold independently of the agricultural vehicle/machine 100, 311.

One or more first fluid lines 411 is/are fluidly coupled to a plurality of first spray nozzles 421A-421F (in general, first spray nozzle(s) 421) that are mounted on the spray boom 430. At least one of the first fluid line(s) 411 is configured to be fluidly coupled to a first tank 111 on an agricultural vehicle (e.g., on the agricultural vehicle/machine 100, 311) either directly or through other first fluid line(s) 441 on the agricultural vehicle.

One or more second fluid lines 412 is/are fluidly coupled to a plurality of second spray nozzles 422A-422F (in general, second spray nozzle(s) 422) that are mounted on the spray boom 430. At least one of the second line(s) 412 is configured to be fluidly coupled to a second tank 112 on the agricultural vehicle (e.g., on the agricultural vehicle/machine 100, 311) either directly or through other second line(s) 442 on the agricultural vehicle. The first line(s) 441, the second line(s) 442, the first tank 111, and the second tank 112 are shown in FIG. 4 for illustration purposes only but are not included on/in the spray boom 430. In other embodiments, the first tank 111 and/or the second tank 112 can be mounted on the spray boom 430, in which case the first line(s) 441 and/or the second line(s) 442 is/are optional.

The spray boom 430 has a length that can be measured with respect to a horizontal axis 450 that is generally orthogonal to a direction of travel of the spray boom 430. The first spray nozzles 421 and the second spray nozzles 422 are mounted and/or spaced along the length of the spray boom 430. Electromechanically actuated valves 431A-431F (in general, first valve(s) 431) are located on and/or fluidly coupled to the first fluid line(s) 411 between the respective first spray nozzles 421 and the first tank 111. Electromechanically actuated valves 432A-432F (in general, second valve(s) 432) are located on and/or fluidly coupled to the second fluid line(s) 412 between the respective second spray nozzles 422 and the second tank 112.

Each valve 431, 432 can include a respective solenoid that allows the respective valve 431, 432 to open and close in response to control signals from a computer 400A, 400B, which can be sent wirelessly and/or over electrical communication lines. In some embodiments, the second spray nozzle(s) 422 can include the respective second valve(s) 432 and/or the first spray nozzle(s) 421 can include the respective first valve(s) 431. An example wired or wireless communication between the computer 400A and valves 431B, 432B and between the computer 400B and valves 431F, 432F is shown in FIG. 4. The computer 400A is also in wired or wireless communication with valves 431A, 431C, 432A, and 432C but such communication is not shown in FIG. 4 so as to not obscure other features in the drawing. Likewise, the computer 400B is also in wired or wireless communication with valves 431D, 431E, 432D, and 432E but such communication is not shown in FIG. 4 so as to not obscure other features in the drawing. Each computer/controller 400A, 400B can be the same as computing device 304. In one or more other embodiments, the computers 400A, 400B can be combined such that only one computer controls the valves 431, 432. In one or more other embodiments, one or more additional computers can be included to control one or more of the valves 431 and/or one or more of the valves 432.

First and second lights 445A, 445B (in general, lights 445) and first and second cameras 440A, 440B are mounted on the spray boom 430. The lights 445 can include light-emitting diodes (LEDs) and/or other lights to provide light (e.g., flash and/or continuous light/illumination) for the agricultural field. The cameras 440 are configured to capture images of the agricultural field along the direction of travel of the spray boom 430. The images captured by each camera 440A, 440B are received by a respective computer 400A, 400B (in general, computer(s) 400) that includes one or more hardware-based processors 402 (e.g., one or more central processing units (CPU(s)), graphics processing units (GPU(s)), and/or other processors and/or microprocessors), memory 404, and other electrical components such as ports (e.g., input/output ports, communication ports). The memory 404 can include transitory memory and non-transitory memory. References to actions or tasks taken by a computer 400 can alternately be referred to as actions or tasks taken by a respective processor(s) 402.

Each computer 400A, 400B can feed the images into one or more trained ML models 405A, 405B (in general, trained ML model(s) 405) to analyze and/or detect the images from a respective camera 400A, 400B for target features (e.g., weeds). The trained ML model(s) 405 can be trained using first images that include the target features and second images that do not include the target features. The trained ML model(s) 405 can be the same as trained ML model(s) 314A.

In other embodiments, the cameras 440 can include or can be replaced with other image/light sensor(s), such as near-IR light sensor(s) and/or fluorescent light sensor(s), that can sense light that represents or corresponds to target features in an agricultural field. Each computer 400 can detect the target features when the intensity of one or more wavelengths of light is above a threshold value. Thus, the trained ML models 405A, 405B can be optional in one or more embodiments.

The field of view (FOV) of each camera 440 and/or other image sensor(s) is aligned with and corresponds to the position of one or more second spray nozzles 422 and to the position of one or more first spray nozzles 421. The fluid circuits for the first tank 111 and the second tank 112 can include additional components, other than those shown in FIG. 4, such as pumps, filters, sensors, and/or other components.

The first spray nozzles 421 and the second spray nozzles 422 are arranged in a plurality pairs 460. Each pair 460 includes one first spray nozzle 421 (and corresponding valve 431) and one second spray nozzle 422 (and corresponding valve 432). The first spray nozzle 421 and the second spray nozzle 422 in each pair 460 are spatially aligned with respect to a respective longitudinal axis 452 that is parallel to the direction of travel of the spray system and that is orthogonal to the horizontal axis 450. A target spray area of a first spray nozzle 421 is spatially aligned with respect to a target spray area of a second spray nozzle 422 in a given pair 460.

Each pair 460 is configured such that only nozzle is activated (e.g., exclusively activated) to spray an herbicide liquid at a time. For example, when a first spray nozzle 421 in a pair 460 is in an active state to spray a first herbicide mixture (e.g., residual herbicide(s)), a respective/corresponding second spray nozzle 422 in the pair 460 is in an inactive state where no herbicides is/are sprayed by the respective SSP nozzle 422. Similarly, when a second spray nozzle 422 in a pair 460 is in an active state to spray a second herbicide mixture (e.g., residual and non-residual herbicides) a respective/corresponding first spray nozzle 421 in the pair 460 is in an inactive state where no herbicide(s) is/are sprayed by the respective first spray nozzle 421.

The first valves 431 and the respective first spray nozzles 421 can have a default active state to apply the residual herbicide(s) onto respective spray regions of the agricultural field. In the active state, the first valves 431 can be repeatedly opened and closed at a frequency and at a variable duty cycle. The duty cycle represents the percentage of each frequency cycle in which a first valve 431 is opened. For example, a duty cycle of 80% indicates that a first valve 431 is opened for 80% of each frequency cycle and closed for 20% of each frequency cycle. Thus, the duty cycle corresponds to the application rate (e.g., GPA) of residual herbicide(s) (e.g., first herbicide mixture) applied by a given first spray nozzle 421. The first valves 431 and the respective first spray nozzles 421 also have an inactive state where the first herbicide mixture is not applied to the agricultural field.

The second valves 432 and the respective second spray nozzles 422 can have a default inactive state where the second herbicide mixture is not applied to the agricultural field. The second valves 432 and the respective second spray nozzles 422 also have an active state in which the second valves 432 can be repeatedly opened and closed at a frequency and at a variable duty cycle such that the respective second spray nozzles 422 spray the second herbicide mixture onto respective spray regions of the agricultural field.

Alternatively, the first valves 431 and the respective second spray nozzles 421 can have a default inactive state and the second valves 432 and the respective second spray nozzles 422 can have a default active state.

The frequency and/or duty cycle of the second valves 432 and/or of the first valves 431 can vary with the speed of the agricultural vehicle (or the speed of the spray boom 430). For example, the duty cycle of the second valves 432 and/or of the first valves 431 can increase when the speed of the agricultural vehicle (or the speed of the spray boom 430) increases or reaches an upper threshold, and the duty cycle can decrease when the speed of the agricultural vehicle (or the speed of the spray boom 430) decreases or reaches a lower threshold. The variable duty cycle of the first valves 431 can cause the target application rate of the residual herbicide(s) (e.g., the first herbicide mixture) to remain the same or about the same (e.g., within about 10%) regardless of the speed of the agricultural vehicle (or of the speed of the spray boom 430). The variable duty cycle of the second valve(s) 432 can cause the target application rate of the second herbicide mixture to remain the same or about the same (e.g., within about 10%) regardless of the speed of the agricultural vehicle (or of the speed of the spray boom 430). The frequency of the second valve(s) 432 can be the same as or different than the frequency of the first valve(s) 431. In addition, the duty cycle of the second valves 432 can be the same as or different than the duty cycle of the first valves 431.

The first and second spray nozzles 421, 422 can be arranged in first and second nozzle groups 451, 452. The first nozzle group 451 includes first spray nozzles 421A-421C and second spray nozzles 422A-422C and is associated with the first camera 440A (and/or other image/light sensor(s)) and the first computer 400A. The second nozzle group 452 includes first spray nozzles 421D-421F and second spray nozzles 422D-422F and is associated with the second camera 445B (and/or other image/light sensor(s)) and the second computer 400B.

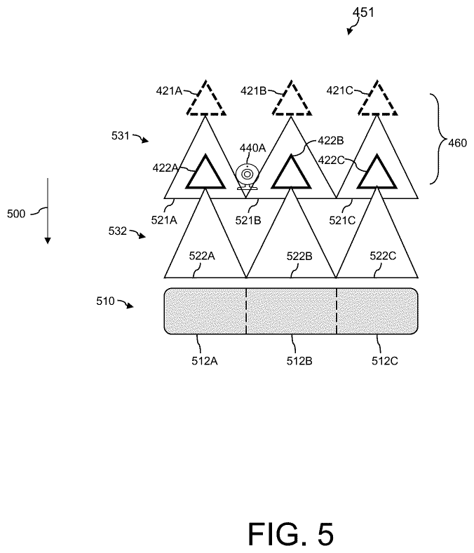

FIG. 5 is an isolated block diagram of the first nozzle group 451 according to one or more embodiments. The first spray nozzles 421A-421C have respective target spray areas 521A-521C (in general, target spray area 521). The second spray nozzles 422A-422C have respective target spray areas 522A-522C (in general, target spray area 522). In each pair 460, a target spray area 521 is spatially aligned with a target spray area 522 such that the same (or substantially the same) area of the agricultural field can be sprayed by a first spray nozzle 521 or a second spray nozzle 522 in a pair 460 by controlling the timing of the spraying. For example, when the direction of travel 500 is downward in the page of FIG. 5, a first spray nozzle 521 would be sprayed later than a second spray nozzle 522 in a pair 460 to spray the same area of the agricultural field. Conversely, a second spray nozzle 522 would be sprayed earlier than a first second spray nozzle 521 in a pair 460 to spray the same area of the agricultural field.

The first spray nozzles 421A-421C are configured and arranged on the spray boom 430 such that the respective target spray areas 521A-521C (e.g., a net first spray area 531 of the first spray nozzles 421A-421C) are spatially aligned with and correspond to an FOV 510 of the first camera 440A (and/or first image/light sensor(s)). Similarly, the second spray nozzles 422A-422C are configured and arranged on the spray boom 430 such that the respective target spray areas 522A-522C (e.g., a net second spray area 532 of the second spray nozzles 422A-422C) are spatially aligned with and correspond to the FOV 510 of the first camera 440A (and/or first image/light sensor(s)).

The target spray areas 521A, 522A of the first spray nozzle 421A and second spray nozzle 422A, respectively, are spatially aligned and can correspond to a first FOV region 512A of the FOV 510. The target spray areas 521B, 522B of the first spray nozzle 421B and second spray nozzle 422B, respectively, are spatially aligned and can correspond to a second FOV region 512B of the FOV 510. The target spray areas 521C, 522C of the first spray nozzle 421C and second spray nozzle 422C, respectively, are spatially aligned and can correspond to a third FOV region 512C of the FOV 510.

An isolated block diagram of the second nozzle group 452 is the same as shown in FIG. 5 for the first nozzle group 451 and is not included for brevity.

When one or more target weeds and/or other target features is/are detected in the light and/or images obtained by a camera 440A (and/or other image/light sensor(s)), the computer 400A can cause (e.g., via control signals) a second valve 432 (and respective second spray nozzle 422) in the nozzle group 451 or 452 associated with the camera 440 (and/or other image/light sensor(s)) and corresponding to the position of the detected target feature (e.g., target weed) in the FOV 510 of the camera 440A (and/or other image/light sensor(s)) to selectively transition to an active state while causing a first valve 431 (and respective first spray nozzle 421) in the pair 460 to transition to an inactive state. A slight delay (e.g., temporal overlap) can occur between transitioning the second valve 432 to the active state and transitioning the first valve 431 to an inactive state and/or between transitioning the first valve 431 to the active state and transitioning the second valve 432 to an inactive state to account for the different relative locations of the second spray nozzle 422 and the first spray nozzle 421 on the spray boom 430, for example when the first spray nozzle 421 is located further away from a target spray area than the second spray nozzle 422. The second valve(s) 432 selected to be activated is/are determined based on the location of the detected target feature(s) within the image/FOV 510. In some embodiments, each pair 460 can include or can be associated with a respective camera 440 (and/or other image/light sensor(s)). For example, a camera 440 (and/or other image/light sensor(s)) can be included or integrated with a second spray nozzle 422 or with a first spray nozzle 421 in some or all pairs 460.

When no target features are detected in the light and/or images obtained by a camera 440 (and/or other image/light sensor(s)), the computer 400A can cause (e.g., via control signals) a first valve 431 (and respective first spray nozzle 421) associated with the camera 440 (and/or other image/light sensor(s)) to transition to (or maintain) an active state while causing a second valve 432 (and respective second spray nozzle 422) in the pair 460 and corresponding to the location within the image/FOV where no target features are detected to transition to (or maintain) an inactive state. As such, each target spray area is sprayed exclusively by only one spray nozzle 421, 422 of each pair 460. When a target spray area is sprayed by a first spray nozzle 421, the target spray area is sprayed with a first herbicide mixture that only includes residual herbicide(s). When a target spray area is sprayed by a second spray nozzle 422, the target spray area is sprayed with a second herbicide mixture that includes both residual and non-residual herbicides.

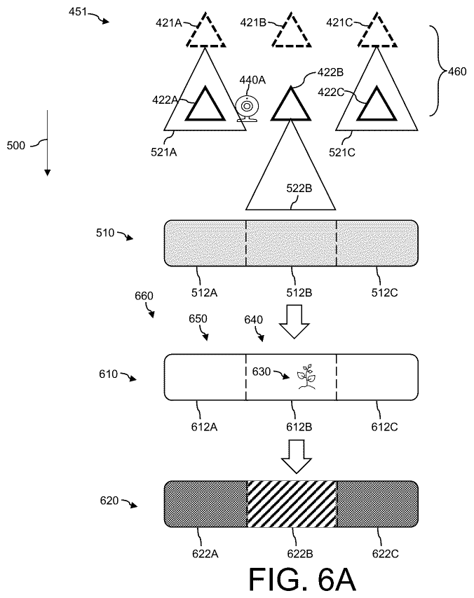

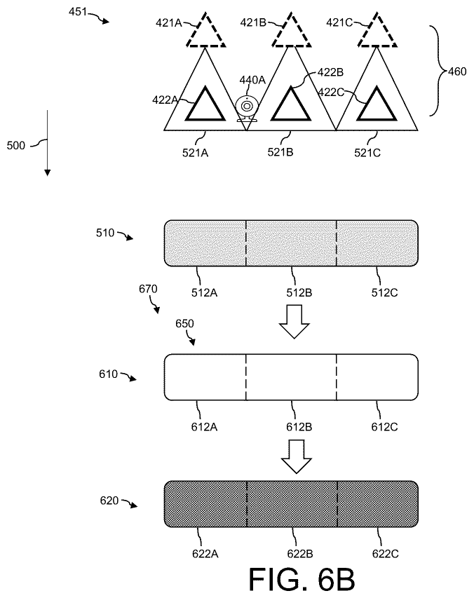

FIG. 6A is an isolated block diagram of the first nozzle group 451 according to one or more embodiments. FIG. 6A is the same as FIG. 5 except that in FIG. 6A the first camera 440A (and/or other image/light sensor(s)) has captured an image 610 of a region 620 of an agricultural field that corresponds to the FOV 510. The computer 400A (e.g., using ML model(s) 405) detects a target weed 630 in image region 612B and does not detect any target weeds 630 in image regions 612A, 612C. The image regions 612A-612C can be generally referred to as image region(s) 612. Image region 612B can be referred to as a weed-detected image region 640. Each image region 612A, 612C can be referred to as a respective weed-absent image region 650. Image 610 can be referred to as a weed-detected image 660. References to an image 610, 660 are used as an example embodiment, but it is noted that the image 610, 660 can be replaced with or can include image data and/or light-sensor data that may or may not be captured from a camera (e.g., first camera 440A).

The computer 400A causes the second spray nozzle 422B (e.g., via second valve 432B (FIG. 4)) to spray target agricultural field area 622B with the second herbicide mixture and causes first spray nozzles 421A, 421C (e.g., via respective first valves 431A, 431C (FIG. 4)) to spray target respective agricultural field areas 622A, 622C with the first herbicide mixture. The target agricultural field areas 622A-C correspond to the image regions 612A-C, respectively, and to the FOV areas 512A-512C, respectively.

An isolated block diagram of the second nozzle group 452 is the same as shown in FIG. 6A for the first nozzle group 451 and is not included for brevity.

FIG. 6B is an isolated block diagram of the first nozzle group 451 according to one or more embodiments. FIG. 6B is the same as FIG. 6A except that in FIG. 6B no target weeds are detected in image regions 612A-C, each image region 612A-612C is a respective weed-absent image region 650, and the image 510 is a weed-absent image 670. References to an image 610, 670 are used as an example embodiment, but it is noted that the image 610, 670 can be replaced with or can include image data and/or light-sensor data that may or may not be captured from a camera (e.g., first camera 440A and/or other image/light sensor(s)).

In response to determining that no weeds are detected, the computer 400A causes the first spray nozzles 421A-421C (e.g., via respective first valves 431A-431C (FIG. 4)) to spray target respective agricultural field areas 622A-622C with the first herbicide mixture.

An isolated block diagram of the second nozzle group 452 is the same as shown in FIG. 6B for the first nozzle group 451 and is not included for brevity.

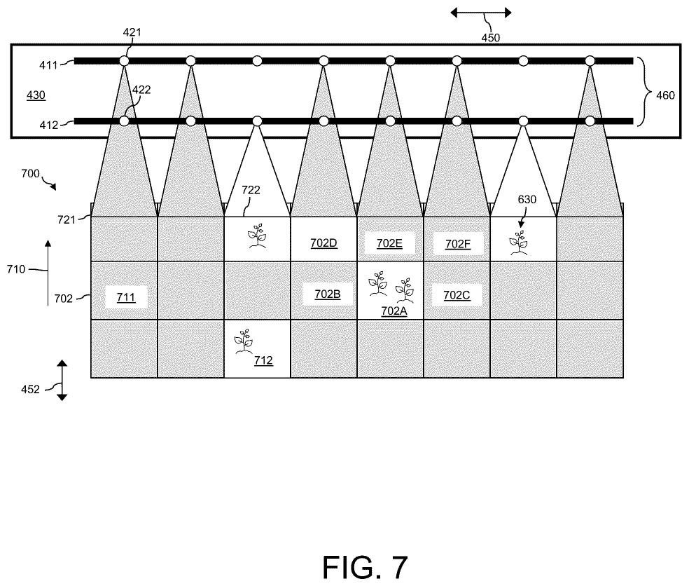

FIG. 7 is a block diagram of the spray boom 430 passing over an agricultural field 700 in a direction 710. The agricultural field 700 is divided into agricultural field areas 702 that correspond to the spray areas 721, 722 of the first and second spray nozzles 421, 422, respectively. The width of each agricultural field area 702, as measured with respect to the horizontal axis 450, corresponds to the width of a spray area 721, 722. The width of each spray area 721, 722 can be the same. The length of each agricultural field area 702, as measured with respect to the longitudinal axis 452, corresponds to the length of time that the first and second spray nozzles 421, 422 are in the on or active state to spray the agricultural field 700. The length of each agricultural field area 702 also corresponds to the FOV 510 of the camera 440 (and/or other image/light sensor(s)) (FIGS. 5, 6).

As the spray boom 430 passes over the agricultural field 700, each agricultural field area 702 is sprayed exclusively by either a first spray nozzle 421 or an second spray nozzle 422 in a given nozzle pair 460. The agricultural field areas 702 sprayed with the first herbicide mixture (e.g., residual herbicide(s)) by a first spray nozzle 421 can be referred to as first-sprayed field areas 711. The agricultural field areas 702 sprayed with the second herbicide mixture (e.g., residual and non-residual herbicides) by a second spray nozzle 422 can be referred to as second-sprayed field areas 712. Each second-sprayed field area 712 includes at least one target weed 630 (and/or other target feature) that was/were detected in the image/image data/light-sensor data by a computer 400.

In one or more embodiments, the application rate of the residual herbicide(s) from one or more of the first spray nozzles 421 can increase from a lower default application rate to an increased application rate in response to the detection of target weed(s) 630 in neighboring regions of the agricultural field. For example, when target weed(s) 630 is/are detected in agricultural field area 702A, agricultural field areas 702B, 702C, 702D, 702E, and/or 702F can be sprayed with the first herbicide mixture (e.g., residual herbicide(s)) at an increased application rate. Agricultural field area 702E would be sprayed by the first spray nozzle 421 in the nozzle pair 460 that included the second spray nozzle 422 that sprayed agricultural field area 702A. Agricultural field areas 702B, 702C, 702D, and/or 702F would be sprayed by a neighboring first spray nozzle 421 in a neighboring nozzle pair 460 to the nozzle pair 460 that included the second spray nozzle 422 that sprayed agricultural field area 702A. The application rate of the first herbicide mixture (e.g., residual herbicide(s)) from a first spray nozzle 421 can be increased by increasing the duty cycle of a respective first spray valve 431 (FIG. 4) compared to a lower default duty cycle to spray at a lower default application rate.

Additionally or alternatively, one or more agricultural field areas 702 can be sprayed with the first herbicide mixture (e.g., residual herbicide(s)) from a first spray nozzle 421 at an increased application rate based, at least in part, on historical weed data.

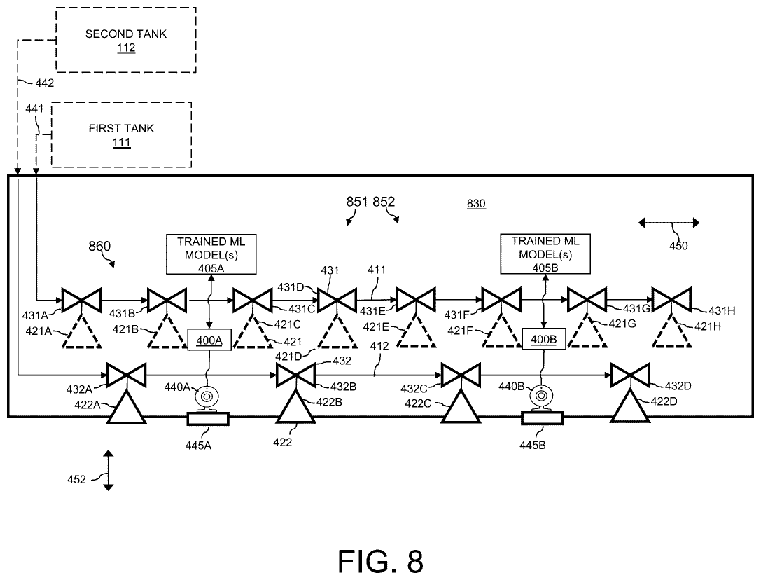

FIG. 8 is a simplified block diagram of an agricultural spray boom 830 according to one or more embodiments. The spray boom 830 is the same as the spray boom 430 except that in the spray boom 830 the first spray nozzles 421 and the second spray nozzles 422 are arranged in first and second nozzle groups 851, 852. The first nozzle group 851 includes first spray nozzles 421A-421D and second spray nozzles 422A, 422B and is associated with the first camera 440A (and/or other image/light sensor(s)). The second nozzle group 852 includes first spray nozzles 421E-421G and second spray nozzles 422C, 422D and is associated with the second camera 440B (and/or other image/light sensor(s)). In each nozzle group 851, 852 there are two first spray nozzles 421 for each second spray nozzle 422 (i.e., a 2:1 ratio of first spray nozzles 421 to second spray nozzles 422). Likewise, there are two first valves 431 for each second valve 432 (i.e., a 2:1 ratio of first valves 431 to second valves 432). Thus, each nozzle group 851, 852 can include more first spray nozzles 421 (and respective first valves 431) than second spray nozzles 422 (and respective second valves 432).

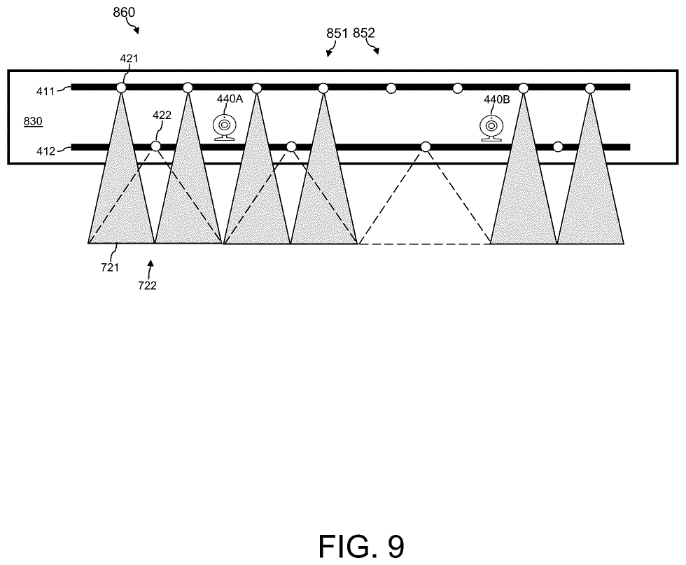

Within a nozzle group 851, 852, a second spray nozzle 422 is associated with two first spray nozzles 421 to form a plurality of nozzle sub-groups 860. Thus, each nozzle sub-group 860 can include more first spray nozzles 421 (and respective first valves 431) than second spray nozzles 422 (and respective second valves 432). In each nozzle sub-group 860, only one nozzle type (first or second) is activated (e.g., exclusively activated) to spray a given target spray area. For example, one nozzle sub-group 860 includes second spray nozzle 422A and first spray nozzles 421A, 421B. Each target spray area of an agricultural field is sprayed exclusively with (a) the first herbicide mixture (e.g., residual herbicide(s)) from one or both of the first spray nozzles 421A, 421B or (b) the second herbicide mixture (e.g., residual and non-residual herbicides) from the second spray nozzle 422A. The second spray nozzles 422 can have a wider spray area 722 than the spray area 721 of the first spray nozzles 421, for example as shown in FIG. 9.

In FIG. 9, the spray areas 721, 722 of the first and second spray nozzles 421, 422 are shown as overlapping for the first nozzle group 851 for illustration purposes only. In general either the second valve 432 or the first valves 431 in a given sub-group 860 is/are activated at any given time, for example as shown with respect to the second nozzle group 852. It is noted that a slight delay/temporal overlap can occur between transitioning a second valve 432 to the active state and transitioning the first valves 431 to an inactive state (or vice versa) to account for the different relative locations of the second spray nozzles 422 and the first spray nozzle 421 on the spray boom 830, for example when the first spray nozzles 421 are located further away from a target spray area than the second spray nozzles 422 (or vice versa).

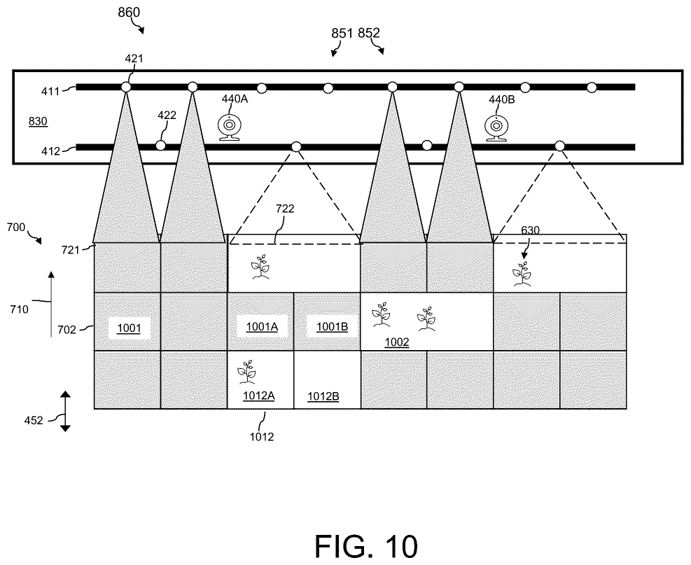

FIG. 10 is a block diagram of the spray boom 830 passing over an agricultural field 700 in a direction 710. The agricultural field 700 includes agricultural field areas 1001, 1002 that have been sprayed exclusively by either the first spray nozzles 421 or the second spray nozzles 422, respectively. For a given nozzle sub-group 860 and image (e.g., image data and/or light-sensor data) of the agricultural field 700, two neighboring agricultural field areas 1001, such as agricultural field areas 1001A, 1001B, are sprayed exclusively with the first herbicide mixture (e.g., residual herbicide(s)) by a respective pair of first spray nozzles 421 when no target weeds 630 are detected in the image regions corresponding to the agricultural field areas 1001A, 1001B. Conversely, for a given nozzle sub-group 860 and image of the agricultural field 700, an agricultural field area 1002 is sprayed exclusively with the second herbicide mixture (e.g., residual and non-residual herbicides) by a respective second spray nozzle 422 when at least one target weed 630 (and/or other target feature) is detected in the image region corresponding to the agricultural field area 1002.

In one or more other embodiments, two neighboring agricultural field areas 1012, such as agricultural field areas 1012A, 1012B, are sprayed with the second herbicide mixture (e.g., residual and non-residual herbicides) by a second spray nozzle 422 in a given nozzle sub-group 860 when at least one target weed 630 (and/or other target feature) is detected in at least one of the neighboring agricultural field areas 1012A, 1012B. The width of an agricultural field area 1012 can be half the width of an agricultural field area 1002 and/or equal to the width of an agricultural field area 1001.

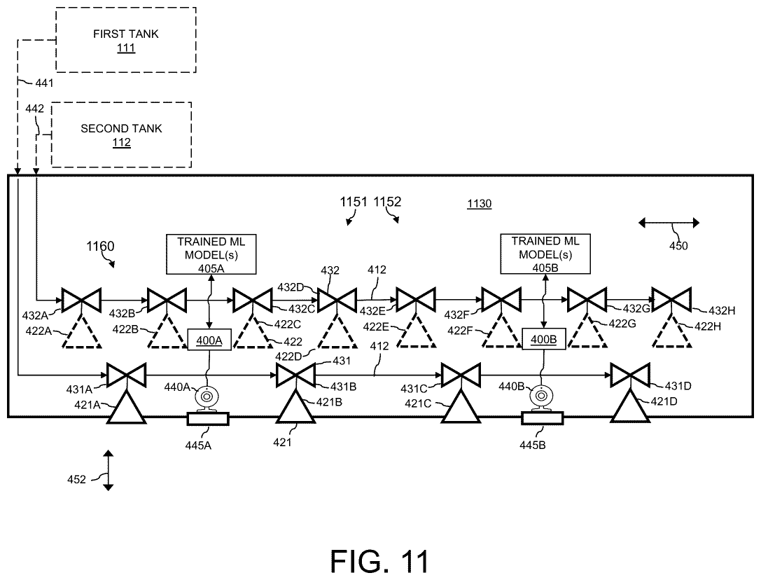

FIG. 11 is a simplified block diagram of an agricultural spray boom 1130 according to one or more embodiments. The spray boom 1130 is the same as the spray boom 830 except that in the spray boom 1130 each nozzle group 1151, 1152 includes two second spray nozzles 422 for each first spray nozzle 421 (i.e., a 1:2 ratio of first spray nozzles 421 to second spray nozzles 422). Likewise, there are two second valves 432 for each first valve 431 (i.e., a 1:2 ratio of first valves 431 to second valves 432). Thus, each nozzle group 1151, 1152 can include more second spray nozzles 422 (and respective second valves 432) than first spray nozzles 421 (and respective first valves 431).

The first nozzle group 1151 includes second spray nozzles 422A-422D and first spray nozzles 421A, 421B and is associated with the first camera 440A (and/or other image/light sensor(s)). The second nozzle group 1152 includes second spray nozzles 422E-422G and first spray nozzles 421C, 421D and is associated with the second camera 440B (and/or other image/light sensor(s)). Within a nozzle group 1151, 1152, a second spray nozzle 422 is associated with two first spray nozzles 421 to form a plurality of nozzle sub-groups 1160. Thus, each nozzle sub-group 1160 can include more second spray nozzles 422 (and respective second valves 432) than first spray nozzles 421 (and respective first valves 431).

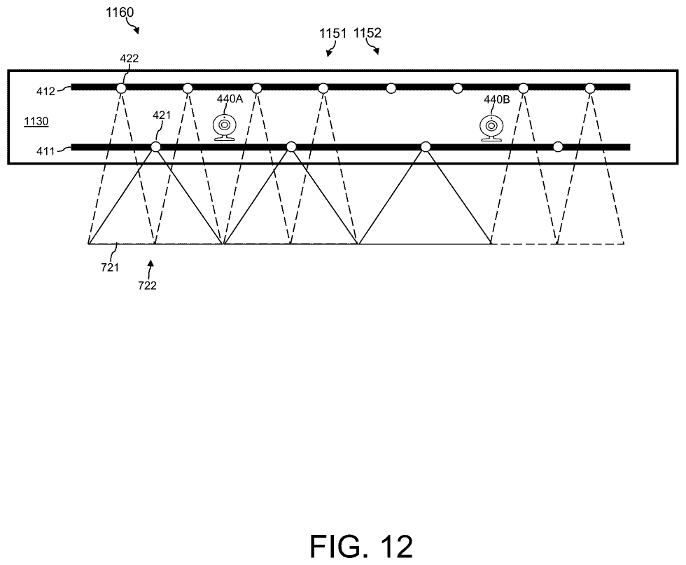

In each nozzle sub-group 1160, only one nozzle type (first or second) is activated to spray a given target spray area. For example, one nozzle sub-group 1160, includes first spray nozzle 421A and second spray nozzles 422A, 422B. Each target spray area of an agricultural field is sprayed exclusively by either (a) one or both of the second spray nozzles 422A, 422B or (b) the first spray nozzle 421A. The first spray nozzles 421 can have a wider spray area 721 than the spray area 722 of the second spray nozzles 422, for example as shown in FIG. 12.

In FIG. 12, the spray areas 721, 722 of the first and second spray nozzles 421, 422 are shown as overlapping for the first nozzle group 1151 for illustration purposes only. In general either the second spray nozzle 422 or the first spray nozzles 421 in a given sub-group 860 is/are activated at any given time, for example as shown with respect to the second nozzle group 1152. It is noted that a slight delay/temporal overlap can occur between transitioning a second valve 432 to the active state and transitioning the first valves 431 to an inactive state (or vice versa) to account for the different relative locations of the second spray nozzles 422 and the first spray nozzle 421 on the spray boom 1130, for example when the first spray nozzles 421 are located further away from a target spray area than the second spray nozzles 422 (or vice versa).

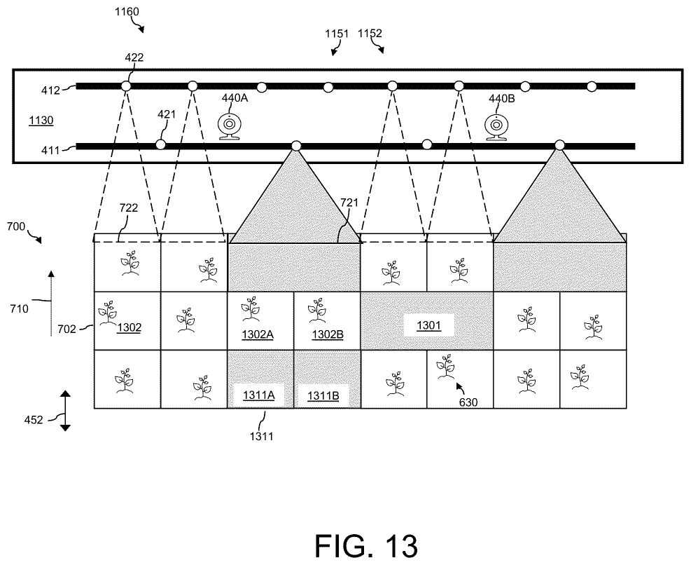

FIG. 13 is a block diagram of the spray boom 1130 passing over an agricultural field 700 in a direction 710. The agricultural field 700 includes agricultural field areas 1301, 1302 that have been sprayed exclusively by either the first spray nozzles 421 or the second spray nozzles 422, respectively. For a given nozzle sub-group 860 and image (e.g., image data and/or light-sensor data) of the agricultural field 700, two neighboring agricultural field areas 1302, such as agricultural field areas 1302A, 1302B, are sprayed exclusively with the second herbicide mixture (e.g., residual and non-residual herbicides) by a respective pair of second spray nozzles 422 when at least one target weed 630 is detected in either agricultural field area 1302A and/or agricultural field area 1302B. Conversely, for a given nozzle sub-group 860 and image of the agricultural field 700, an agricultural field area 1002 is sprayed exclusively with the first herbicide mixture (e.g., residual herbicide(s)) by a respective first spray nozzle 421 when no target weeds 630 are detected in the image region corresponding to the agricultural field area 1001.

In one or more other embodiments, two neighboring agricultural field areas 1311, such as agricultural field areas 1311A, 1311B, are sprayed by a first spray nozzle 421 in a given nozzle sub-group 860 when no target weeds 630 are detected in either of the neighboring agricultural field areas 1311A, 1311B. The width of an agricultural field area 1311 can be half the width of an agricultural field area 1301 and/or equal to the width of an agricultural field area 1302.

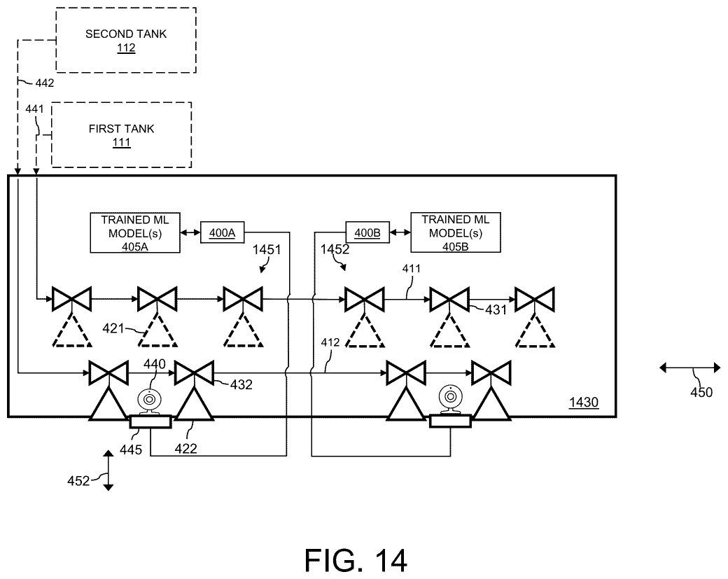

FIG. 14 is a simplified block diagram of an agricultural spray boom 1430 according to one or more embodiments. The spray boom 1430 is the same as the spray boom 430 except that in the spray boom 1430 each nozzle group 1451, 1452 includes two second spray nozzles 422 for every three first spray nozzles 421 (i.e., a 3:2 ratio of first spray nozzles 421 to second spray nozzles 422). Likewise, there are two second valves 432 for every three first valves 431 (i.e., a 3:2 ratio of first valves 431 to second valves 432). Thus, each nozzle group 1451, 1452 can include more first spray nozzles 421 (and respective first valves 431) than second spray nozzles 422 (and respective second valves 432).

In each nozzle group 1451, 1452, only one nozzle type (first or second) is activated to spray a given target spray area.

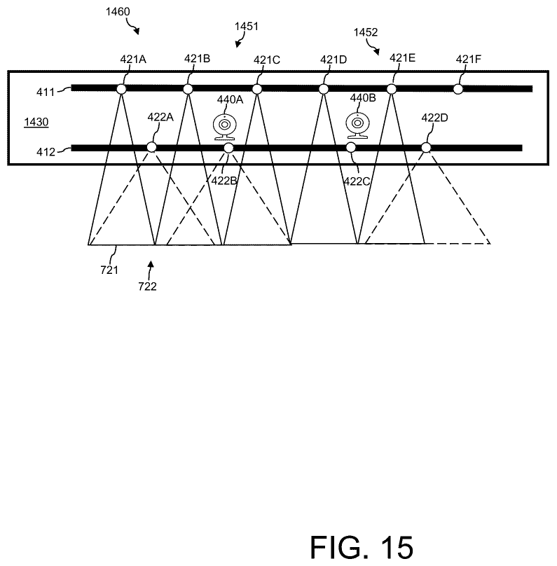

The second spray nozzles 422 can have a wider spray area 722 than the spray area 721 of the first spray nozzles 421, for example as shown in FIG. 15.

In FIG. 15, the spray areas 721, 722 of the first and second spray nozzles 421, 422 are shown as overlapping for the first nozzle group 1451 for illustration purposes only. In each nozzle group 1451, 1452, each second spray nozzle 422 is associated with two first spray nozzles 421 to form a nozzle sub-group 1460. For example, a first nozzle sub-group 1460 of nozzle group 1451 includes second spray nozzle 422A and first spray nozzles 421A, 421B. A second nozzle sub-group 1460 of nozzle group 1451 includes second spray nozzle 422B and first spray nozzles 421B, 421C. The center first spray nozzle 421B is common to the first the second nozzle sub-groups 1460. When a target region of an agricultural field that includes one or more target weeds is sprayed exclusively with the second herbicide mixture (e.g., residual and non-residual herbicides) by the second spray nozzle 422A, the first spray nozzles 421A, 421B are inactivated so as to not spray the same target region with the first herbicide mixture (e.g., residual herbicide(s)). Similarly, when a target region of an agricultural field that includes one or more target weeds is sprayed exclusively with the second herbicide mixture (e.g., residual and non-residual herbicides) by the second spray nozzle 422B, the first spray nozzles 421B, 421C are inactivated so as to not spray the same target region with the first herbicide mixture (e.g., residual herbicide(s)). Each nozzle sub-group 1460 can include more first spray nozzles 421 (and respective first valves 431) than second spray nozzles 422 (and respective second valves 432).

When a target region of an agricultural field does not include any target weeds, a pair of first spray nozzles 421 is activated to spray the target region. For example, a target region of an agricultural field that does not include any target weeds can be sprayed exclusively with the first herbicide mixture (e.g., residual herbicide(s)) by first spray nozzles 421A, 421B, in which case the second spray nozzle 422A in the associated nozzle sub-group 1460 does not spray the second herbicide mixture (e.g., residual and non-residual herbicides) onto the target region. Similarly, a target region of an agricultural field that does not include any target weeds can be sprayed exclusively with the first herbicide mixture (e.g., residual herbicide(s)) by broadcast nozzles 421B, 421C, in which case the SSP nozzle 422B in the associated nozzle sub-group 1460 does not spray the second herbicide mixture (e.g., residual and non-residual herbicides) onto the target region.

The second nozzle group 1452 is illustrated to show first spray nozzles 421D, 421E activated to spray a target region while second spray nozzle 422C in the associated nozzle sub-group 1460 does not spray the target region. The second nozzle group 1452 is also illustrated to show second spray nozzle 422D activated to spray a target region while first spray nozzle 421F does not spray the target region.

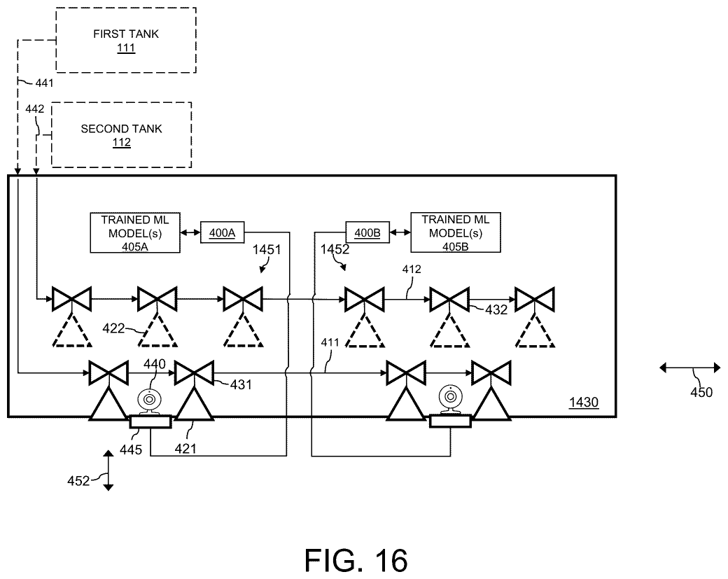

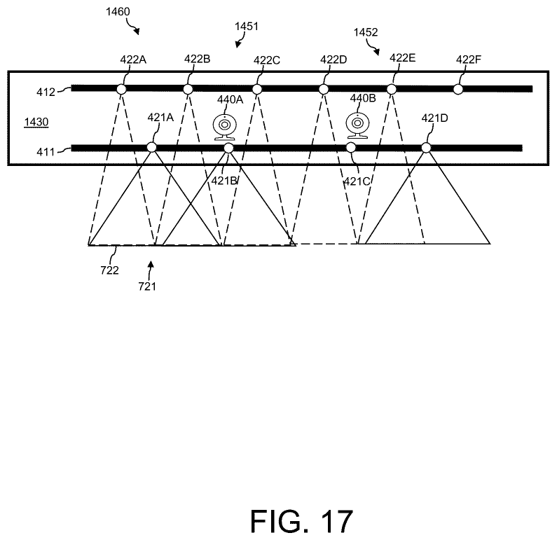

In one or more other embodiments, the first and second spray nozzles 421, 422 can have the opposite configuration as that shown in FIGS. 14 and 15 such that there are two first spray nozzles 421 for every three second spray nozzles 422 (i.e., a 2:3 ratio of first spray nozzles 421 to second spray nozzles 422). Likewise, there can be two first valves 431 for every three second valves 432 (i.e., a 2:3 ratio of first valves 431 to second valves 432). An example of this configuration is shown in FIGS. 16 and 17. Thus, each nozzle group 1451, 1452 can include more second spray nozzles 422 (and respective second valves 432) than first spray nozzles 421 (and respective first valves 431).

Referring to FIG. 17, when target regions of an agricultural field that include one or more target weeds are sprayed exclusively with the second herbicide mixture (e.g., residual and non-residual herbicides) by second spray nozzles 422A, 422B, the first spray nozzle 421A is inactivated so as to not spray the same target regions with the first herbicide mixture (e.g., residual herbicide(s)). Similarly, when target regions of an agricultural field that include one or more target weeds are sprayed exclusively with the second herbicide mixture (e.g., residual and non-residual herbicides) by second spray nozzles 422B, 422C, the first nozzle 421B is inactivated so as to not spray the same target regions with the first herbicide mixture (e.g., residual herbicide(s)).

In one or more embodiments, when target weed(s) is/are detected in one target region, a second spray nozzle 422A or 422B can spray the target region with the detected weed(s) and a first spray nozzle 421B can spray a neighboring target region where no weeds are detected.

The second nozzle group 1452 is illustrated to show second spray nozzles 422D, 422E as activated to spray respective target regions with detected weeds while first spray nozzle 421C in the associated nozzle sub-group 1460 does not spray the target regions. The second nozzle group 1452 is also illustrated to show first spray nozzle 421D as activated to spray a target region without detected weeds while second spray nozzle 422F does not spray the target region.

Each nozzle sub-group 1460 can include more second spray nozzles 422 (and respective second valves 432) than first spray nozzles 421 (and respective first valves 431).

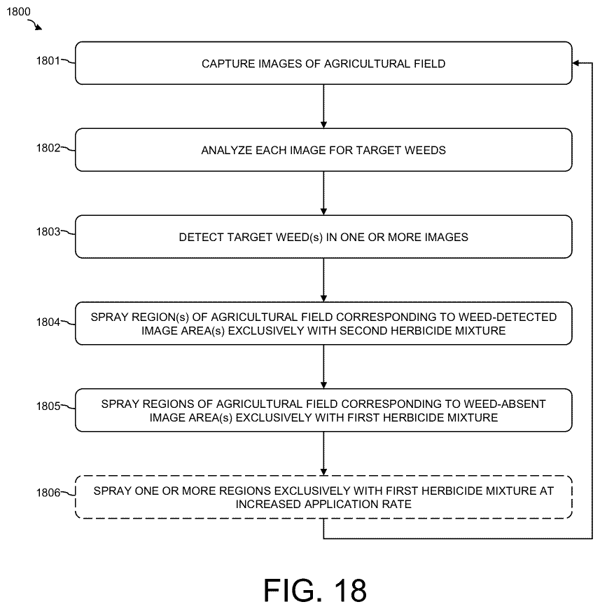

FIG. 18 is a flow chart of a method 1800 for spraying an agricultural field according to one or more embodiments. The method 1800 can be performed using an agricultural spray system 10, 20, or 30, such as with a spray boom 130, 311, 430, 830 1130, or 1430.

In step 1801, images of respective regions of an agricultural field are captured using one or more cameras 440 and/or image sensors 312 mounted on a spray boom. The captured images can include image data, image-sensor data, and/or light-sensor data. The respective regions are located in front of the spray boom 130 (e.g., along its direction of travel) and are located laterally from each other (e.g., along or parallel to a horizontal axis 450). The spray boom can be pushed or pulled by the agricultural vehicle.

The camera(s) 440 and/or image sensor(s) 312 can be separate from the spray nozzles or included/integrated with one of the spray nozzles, such as with the first spray nozzles 421 or with the second spray nozzles 422. Each camera(s) 440 and/or image sensor(s) 312 has a respective FOV 510 that can be subdivided into a plurality of regions such as FOV regions 512A-512C. Each FOV region 512A-512C corresponds to a respective image region 612A-612C. The captured images can be the same as image 610.

In step 1802, each captured image is analyzed by a computer (e.g., computer 400) for the presence or indicia of one or more target weeds (and/or other target feature(s)). In one example, the intensity of one or more wavelengths can be compared to predetermined threshold(s) to determine whether any target weeds (and/or other target feature(s)) may be present. In another example, the computer can feed each captured image into one or more trained ML models (e.g., ML model(s) 405) configured to detect target weeds (and/or other target feature(s)) in images. Each camera(s) 440 and/or image sensor(s) 312 can be associated with and/or in communication with a respective computer 400 that can analyze the images. Alternatively, a computer can analyze the images 610 captured by more than one camera 440 and/or more than one image sensors 312 using one or more respective trained ML models 405.

In step 1803, at least one target weed 630 is/are detected in one or more of the captured images 630. For example, at least one target weed 630 can be detected in one or more image areas 612 of one or more captured images 630.

In step 1804, the respective region(s) of the agricultural field corresponding to the detected weed(s) is/are sprayed with a second herbicide mixture (e.g., residual and non-residual herbicides) using a respective second spray nozzle 422. For example, for each weed-detected image area 640, the respective region(s) of the agricultural field corresponding to the detected weed(s) is/are sprayed with the second herbicide mixture (e.g., residual and non-residual herbicides) using a respective second spray nozzle 422. The second spray nozzle 422 that sprays a given weed-detected image area 640 is associated with the camera(s) 440 or image sensor(s) 312 that captured the image 610 that includes the weed-detected image area 640 and has a spray area that is spatially aligned with the respective region of the agricultural field. The second spray nozzle 422 can be in a spray group 451, 452 that is associated with the camera(s) 440 or image sensor(s) 312 that captured the image 610 (and/or sensor data and/or light-sensor data) that includes the weed-detected image area 640.

The selective spot spraying of the second herbicide mixture can be performed by transitioning the valve(s) 432 for the respective second spray nozzle(s) 422 from an inactive state to an active state. In the active state, the second spray valve(s) 432 can be opened and closed at a frequency and at a duty cycle. The duty cycle can be varied according to the speed of the agricultural vehicle and/or the height of the spray boom such that the application rate of the herbicidal mixture is substantially uniform (e.g., varies less than or equal to about 10%). The valve(s) 431 for the first spray nozzles 421 in the pair(s) 460 and/or nozzle sub-groups 1160 (FIGS. 11, 12) that include the activated second spray nozzle(s) 422 is/are transitioned from an active state to an inactive state (or are maintained in the inactive state) such that the region(s) of the agricultural field with at least one target weed, corresponding to each weed-detected image area 640, is/are sprayed exclusively with the second herbicide mixture by only the respective/corresponding second spray nozzle(s) 422.

In step 1805, for each weed-absent image area 650, the respective region of the agricultural field is sprayed exclusively with the first herbicide mixture (e.g., residual herbicide(s)) using a respective first spray nozzle 421. The first spray nozzle 421 that sprays a given weed-absent image area 650 is associated with the camera(s) 440 or image sensor(s) 312 that captured the image 610 that includes the weed-absent image area 650 and has a spray area that is spatially aligned with the respective region of the agricultural field. The first spray nozzle 421 can be in a spray group 451, 452 that is associated with the camera(s) 440 or image sensor(s) 312 that captured the image 610 (and/or sensor data and/or light-sensor data) that includes the weed-detected image area 640.

The broadcast spraying can be performed by transitioning the valve(s) 431 for the respective broadcast nozzle(s) 421 from an inactive state to an active state. In the active state, the broadcast valve(s) 431 is/are opened and closed at a frequency and at a default duty cycle. The default duty cycle can be varied according to the speed of the agricultural vehicle and/or the height of the spray boom such that the application rate of the residual herbicide(s) is substantially uniform (e.g., varies less than or equal to about 10%). The respective valve(s) 432 for the SSP nozzles 422 in the pair(s) 460 and/or nozzle sub-groups 1160 (FIGS. 11, 12) that include the activated broadcast nozzle(s) 421 is/are transitioned from an active state to an inactive state (or are maintained in the inactive state) such that the region(s) of the agricultural field with no target weeds, corresponding to each weed-absent image area 650, is/are sprayed by only the broadcast nozzle(s) 421.

In optional step 1806, one or more regions of the agricultural field that correspond to a respective weed-absent image area 650 is/are sprayed exclusively with the first herbicide mixture (e.g., residual herbicide(s)) at an increased application rate (compared to a default application rate) using one or more first spray nozzle(s) 421 and respective valve(s) 431. The regions sprayed with the first herbicide mixture (e.g., residual herbicide(s)) at an increased application rate can include neighboring region(s) that is/are adjacent to the region(s) where target weed(s) and/or a cluster of target weeds is/are detected. Additionally or alternatively, the region(s) sprayed with the first herbicide mixture (e.g., residual herbicide(s)) at an increased application rate can include region(s) having a high (e.g., above a threshold value) weeds concentration in prior years (e.g., based on historical weed data). Spraying the first herbicide mixture (e.g., residual herbicide(s)) at an increased application rate can include operating the respective valves 431 at a higher duty cycle compared to a default duty cycle.

Steps 1801-1806 can be repeated as the agricultural vehicle passes over the agricultural field.

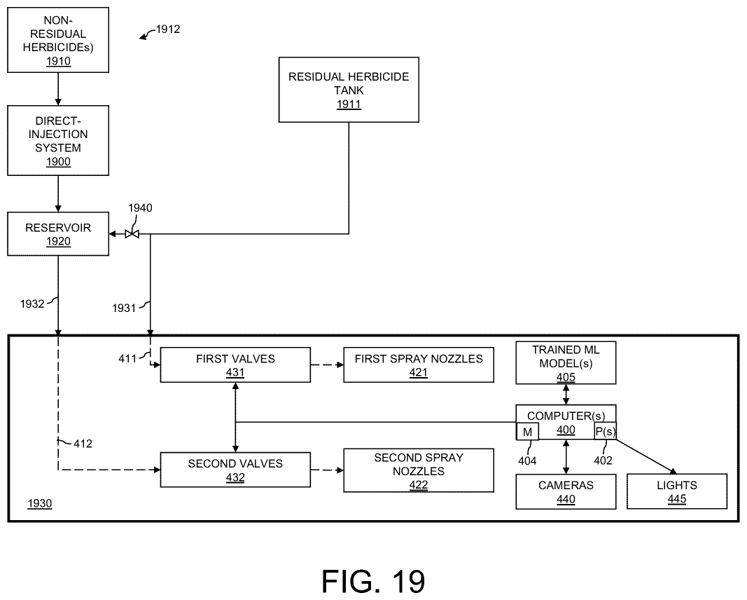

FIG. 19 is a simplified block diagram of fluid and electrical circuits for an agricultural spray system 10, 20, 30 according to one or more embodiments. A spray boom 1930 includes one or more first fluid lines 411 and one or more second fluid lines 412. The first fluid line(s) 411 is/are fluidly coupled to a plurality of first valves 431 which are fluidly coupled to a plurality of first spray nozzles 421. The second fluid line(s) 412 is/are fluidly coupled to a plurality of second spray valves 432 which are fluidly coupled to a plurality of second nozzles 422.

The first fluid line(s) 411 on the spray boom 1930 is/are fluidly coupled to a residual herbicide tank 1911 on an agricultural vehicle by one or more fluid lines 1931. The residual herbicide tank 1911 includes one or more residual herbicides. The residual herbicide tank 1911 can be the same as a first tank 111 such that the first herbicide mixture (e.g., residual herbicide(s)) can be stored in the residual herbicide tank 1911. The fluid line(s) 1931 can be disposed on the agricultural vehicle and can extend between the residual herbicide tank 1911 and the spray boom 1930. The fluid line(s) 1931 are also fluidly coupled to a reservoir tank 1920.

The reservoir tank 1920 is configured to hold and mix an herbicide mixture that includes the residual herbicide(s) from the residual herbicide tank 1911 and one or more non-residual herbicides 1910. The non-residual herbicide(s) 1910 are injected or introduced into the reservoir 1920 by a direct injection system 1900 produces an herbicide mixture having a predetermined concentration of non-residual herbicide(s) 1910. The non-residual herbicide(s) 1910 can be in a concentrated form such as in a concentrated liquid, a powder, pellets, a gel, and/or another concentrated form, to reduce space and weight. A valve 1940 can control the volume of the residual herbicide(s) from the residual herbicide tank 1911 that flows into the reservoir tank 1920 to adjust a concentration and/or a volume of residual herbicide(s) and/or a concentration and/or a volume of non-residual herbicide(s) 1910 in the herbicide mixture stored in the reservoir tank 1920. The non-residual herbicide(s) 1910 can be stored in a tank, vessel, or container 1912. The herbicide mixture formed in the reservoir 1920 can be the same as the second herbicide mixture (e.g., residual and non-residual herbicides).

The reservoir tank 1920 can be sized to store a sufficient volume of mixed herbicides to be used (e.g., on average) by the second spray nozzles 422. For example, when the second spray nozzles 422 are activated for about 10% of the time (on average), the volume of the reservoir tank 1920 can be about 10% of the volume of the residual herbicide tank 1911. The reservoir tank 1920 can have other volumes in other embodiments. Additionally or alternatively, the reservoir tank 1920 can be configured to allow the direct-injection system 1900 to run continuously.

The reservoir tank 1920 can be pressurized such that the reservoir 1920 can function as a mixing tank. Alternatively, the reservoir tank 1920 can be unpressurized (e.g., operating at atmospheric pressure) and a pump can be included downstream of the reservoir tank 1920. The second fluid line(s) 412 on the spray boom 1930 are fluidly coupled to the reservoir by one or more fluid lines 1932.

The respective spray areas of the broadcast nozzles 421 and SSP nozzles 422 can be partially or fully spatially aligned, such that each region of an agricultural field is selectively sprayed exclusively with residual herbicide(s) (e.g., the first herbicide mixture) or with an herbicide mixture (e.g., the second herbicide mixture).

One or more computers 400 produce control signals that control the state of each first valve 431 and each second valve 432 so that each region of an agricultural field is selectively sprayed with residual herbicide(s) (e.g., the first herbicide mixture) only (e.g., exclusively) by a respective first spray nozzle 421 or with an herbicide mixture (e.g., the second herbicide mixture) by a respective second spray nozzle 422 as described herein. The computer(s) 400 analyze images (e.g., image data, sensor data, and/or light-sensor data) captured by cameras 440 and/or other image sensors for one or more target weeds (e.g., target weeds 630). For each weed-detected image area 640, the respective region of the agricultural field is selectively sprayed with only (e.g., exclusively) the herbicide mixture (e.g., a second herbicide mixture (e.g., residual and non-residual herbicides)) by a respective second spray nozzle 422. For each weed-absent image area 650, the respective region of the agricultural field is selectively sprayed with only (e.g., exclusively) one or more residual herbicides (e.g., a first herbicide mixture) by a respective first spray nozzle 421. The spray boom 1930 can be the same as the spray boom 130, 311, 430, 830 1130, or 1430.

In one or more alternative embodiments, the first and second spray nozzles 421, 422 can be spatially arranged in various configurations. For example, only some (or none) of the respective spray areas of the first spray nozzles 421 and the second spray nozzles 422 can be spatially aligned partially or fully, while others (or all) of the respective spray areas of the first spray nozzles 421 and the second spray nozzles 422 can be not spatially aligned. The first spray nozzles 421 can be configured to spray in broadcast mode where the broadcast nozzles 421 spray the agricultural field continuously or substantially continuously (e.g., at a duty cycle that can be variable) as the spray boom 1930 moves across the agricultural field. The broadcast nozzles 421 can apply the one or more residual herbicides (e.g., the first herbicide mixture) at a uniform or substantially uniform application rate across some or all of the length of the spray boom 1930. One or more second spray nozzles 422 selectively sprays the herbicide mixture (e.g., the second herbicide mixture) onto respective region(s) of the agricultural field when weed(s) is/are detected in the respective region(s).

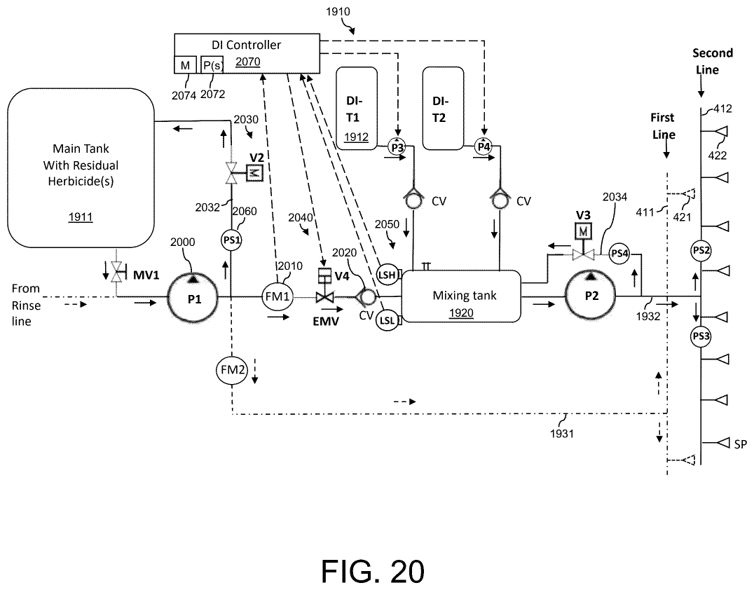

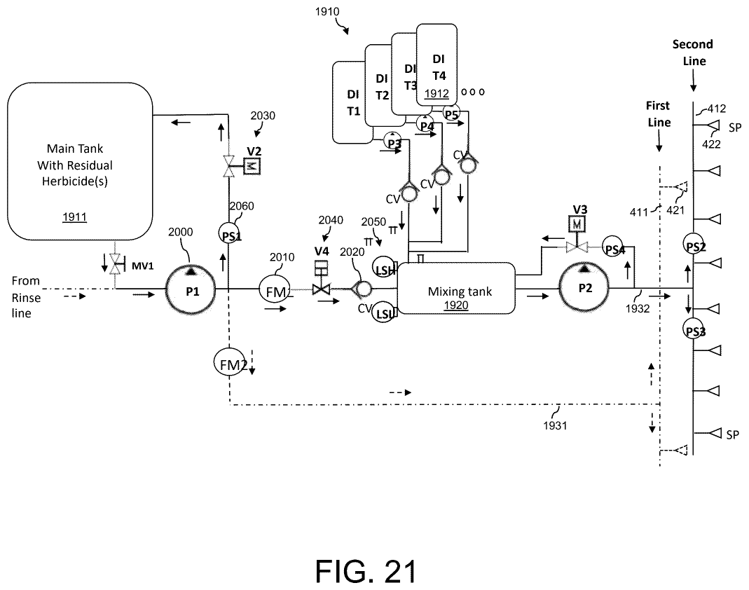

FIG. 20 is a detailed block diagram of the fluid circuits shown in FIG. 19 according to one or more embodiments. The fluid circuits can include a plurality of pumps (P1-P4) 2000, flow meters (FM1, FM2) 2010, check valves (CVs) 2020, manual valves (MV1-MV3) 2030, an electromechanical valve (EMV) 2040, limit switches (LSH, LSL) 2050, and/or pressure sensors (PS1-PS4) 2060. Two non-residual herbicide tanks (e.g., direct-injection tanks) 1912 are shown in FIG. 20. Each non-residual herbicide tank 1912 can hold one or more non-residual herbicides 1910. In one or more embodiments, only one non-residual herbicide tank 1912 can be included. In one or more embodiments, additional non-residual herbicide tanks 1912 can be included, for example as shown in FIG. 21 which includes a plurality (e.g., four) non-residual herbicide tanks 1912. Each non-residual herbicide tank 1912 is fluidly coupled to a respective fluid line, a respective pump 2000, and a respective check valve 2020.

Referring to FIG. 20, a direct-injection (DI) controller 2070 is configured to have inputs and outputs that allow the DI controller 2070 to control the fluid circuits for an agricultural spray system. The DI controller 2070 includes one or more hardware-based processors 2072 (e.g., one or more central processing units (CPU(s)), graphics processing units (GPU(s)), and/or other processors and/or microprocessors), memory 2074, and other electrical components such as ports (e.g., input/output ports, communication ports). The memory 2074 can include transitory memory and non-transitory memory.

The DI controller 2070 receives as inputs the output of the flow meter 2010 FM1, the output of a high limit switch LSH, and the output of a low limit switch LSL. The output of the flow meter 2010 FM1 represents the measured flow rate of the residual herbicide(s) from the residual herbicide tank 1911 that enters the mixing tank 1920. The DI controller 2070 produces control signals as outputs for the EMV 2040 V4, and pumps 2000 P3, P4 (and any additional pumps 2000, such as pump P5 in FIG. 21, coupled to a respective non-residual herbicide tank 1912). The flow rate of the residual herbicide(s) from the residual herbicide tank 1911 that enters the mixing tank 1920 can be adjust by changing the state of the EMV 2040 V4.

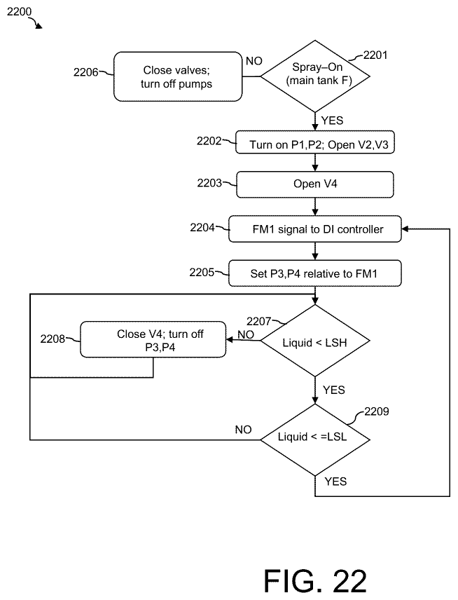

FIG. 22 is a flow chart of a method 2200 for controlling the fluid circuits for an agricultural spray system that includes a direct-injection system. The method 2200 can be performed with a DI controller 2070.

In step 2201, the controller 2070 determines whether the agricultural spray system is in set to on or in operation. If so (i.e., step 2201=yes), the method proceeds to steps 2202-2205 to open. If not (i.e., step 2201=no), the method proceeds to step 2206 where all valves 2030, 2040 are closed and all pumps 2000 are turned off.

In step 2202, pumps 2000 P1, P2 are turned on and manual valves 2030 MV2, MV3 are opened. In general, the pump 2000 P1 is on or working when the agricultural spray system is in operation. The pump 2000 P1 can maintain a constant pressure (or substantially constant pressure within upper and lower process control limits). When the pressure (e.g., as measured at pressure sensor 2060 PS1) increases or decreases (e.g., relative to the upper or lower process control limit), the pump 2000 P1 compensates by changing its rotation speed.

The pump 2000 P2 is on or working when the SSP system is in operation. The pump 2000 P2 can maintain a constant pressure (or substantially constant pressure within upper and lower process control limits). When the pressure (e.g., as measured at pressure sensor 2060 PS2 and/or at PS3) increases or decreases (e.g., relative to the upper or lower process control limit), the pump 2000 P2 compensates by changing its rotation speed.

The manual valve 2030 MV2 is fluidly coupled to a first agitation line 2032 that recirculates the residual herbicide(s) to the residual herbicide tank 1911 when the pump 2000 P1 is in operation. The pressure sensor 2060 PS1 can indicate (e.g., based on upper and lower process control limits) whether to increase or decrease the agitation (e.g., recirculation rate) to the residual herbicide tank 1911.

The manual valve 2030 MV3 is fluidly coupled to a second agitation line 2034 that recirculates the herbicidal mixture to the mixing tank 1920 when the pump 2000 P2 is in operation. The pressure sensor 2060 PS4 can indicate (e.g., based on upper and lower process control limits) whether to increase or decrease the agitation (e.g., recirculation rate) to the mixing tank 1920.

In step 2203, the EMV 2040 V4 is opened to allow the residual herbicide(s) to enter the mixing tank 1920.

In step 2204, the DI controller 2070 receives the measured flow rate, by the flow meter 2010 FM1, of the residual herbicide(s) into the mixing tank 1920.

In step 2205, the pumps 2000 P3, P4 are turned on and the pressure set points of the pumps 2000 P3, P4 (and any additional pumps for any other respective non-residual herbicide tanks 1912) are set based on or based in part on the measured flow rate output from the flow meter 2010 FM1. The pressure set points can be determined based on a look-up table, a model, set-point ranges, and/or other factors. The pressure set points can be determined to provide a predetermined flow rate of the non-residual herbicides 1912 and/or to provide a predetermined ratio of residual and non-residual herbicides in the herbicidal mixture (e.g., the second herbicide mixture) formed in mixing tank 1920.

In step 2207, the DI controller 2070 determines whether the volume of liquid in the mixing tank 1920 is below an upper limit as determined by the state of the high limit switch 2050. If the volume of liquid in the mixing tank 1920 is greater than or equal to the upper limit (i.e., step 2207=no) such that the high limit switch 2050 is activated, the method proceeds to step 2208 where the DI controller 2070 causes the EMV valve 2040 V4 to close and the pumps 2000 P3, P4 to shut off to prevent additional liquid (e.g., residual and non-residual herbicides) from entering the mixing tank 1920. Steps 2207 and 2208 can repeat in a loop until the volume of liquid in the mixing tank 1920 falls below the upper limit (e.g., until the high limit switch 2050 is not activated).

If the volume of liquid in the mixing tank 1920 is below the upper limit (i.e., step 2207=yes), the method proceeds to step 2209 where the DI controller 2070 determines whether the volume of liquid in the mixing tank 1920 is below or equal to a lower limit as determined by the state of the low limit switch 2050.

If the volume of liquid in the mixing tank 1920 is above the lower limit (e.g., the volume is between the upper and lower limits) such that the low limit switch 2050 is not activated (i.e., step 2209=no), the method returns to step 2207 in a loop. If the volume of liquid in the mixing tank 1920 is below or equal to the lower limit such that the low limit switch 2050 is not activated (i.e., step 2209=yes), the method returns to step 2204 in a loop.

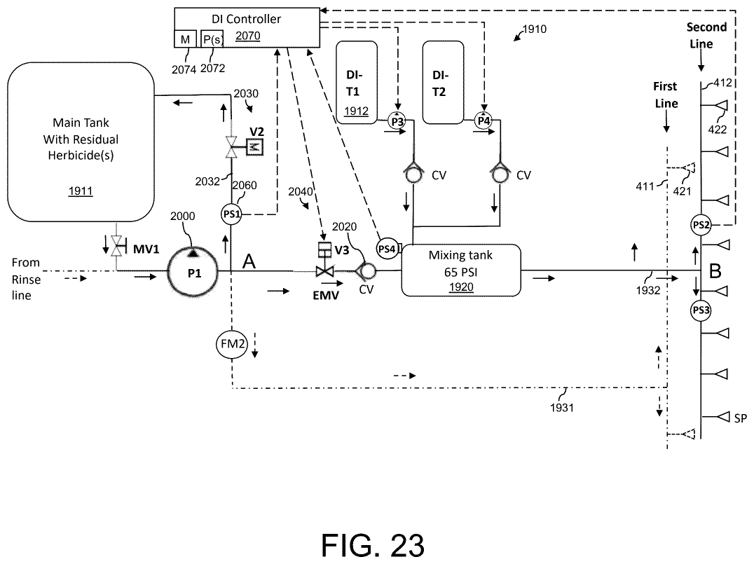

FIG. 23 is a detailed block diagram of the fluid and electrical circuits shown in FIG. 19 according to one or more alternative embodiments. In FIG. 23, the mixing tank 1920 is pressurized and the pressure of the mixing tank 1920 is measured by a pressure sensor 2060 PS4. A DI controller 2070 receives as inputs the pressure measured by a pressure sensor 2060 PS1, the pressure measured by pressure sensor 2060 PS2, and the pressure measured by pressure sensor 2060 PS4. The DI controller 2070 produces output control signals that control the EMV 2040 V3, the pump 2000 P3, and the pump 2000 P4. The DI controller 2070 can be programmed to assume that the pressure measured at point A (e.g., the pressure measured by pressure sensor 2060 PS1) is constant. The EMV 2040 V3 and the pumps 2000 P3, P4 controlled such that the mixing chamber pressure (e.g., as measured by pressure sensor 2060 PS4) and/or the SSP line 412 pressure (e.g., as measured by pressure sensor 2060 PS2) reach a set-point and/or are within upper and lower process control limits.

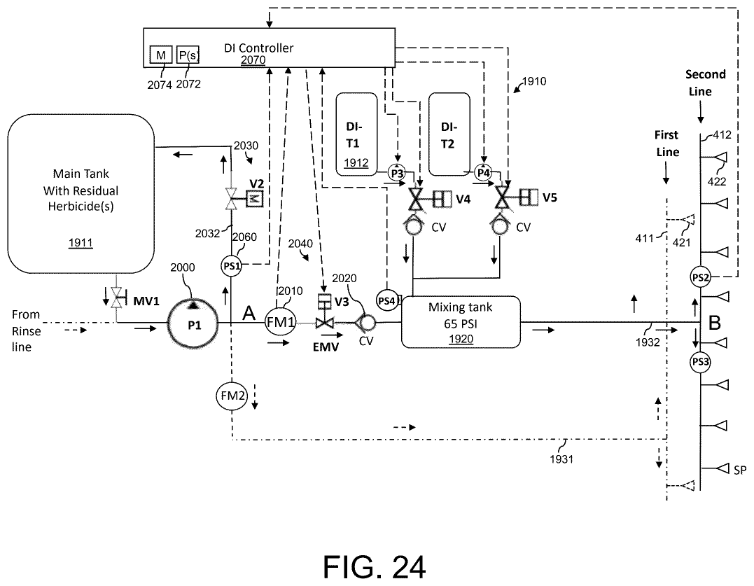

FIG. 24 is a detailed block diagram of the fluid and electrical circuits shown in FIG. 19 according to one or more alternative embodiments. FIG. 24 is the same as FIG. 23 except that in FIG. 24, the DI controller 2070 has an additional input coupled to a flow meter 2010 FM1 and additional outputs coupled to EMV valves 2040 V4, V5. The DI controller can control pumps 2000 P3, P4 based on or based in part on the flow rate of the residual herbicide(s) into the mixing tank 1920 as measured by flow meter 2010 FM1. The EMV 2040 V3 can open when the measured pressure at pressure sensor 2060 PS1 or at pressure sensor 2060 PS2 falls below a set point (or below a set point range). The embodiment shown in FIG. 24 can be used when the second spray valves 422 are pulse-width modulated (PWM) valves.

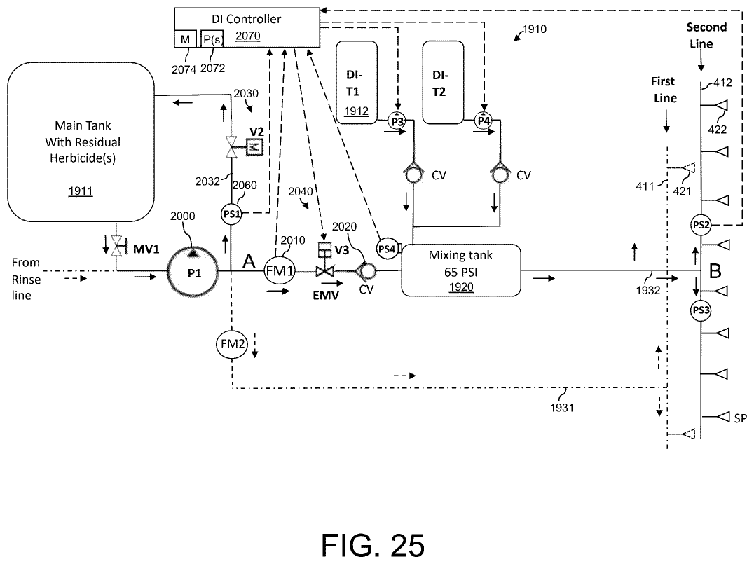

FIG. 25 is a detailed block diagram of the fluid circuits shown in FIG. 19 according to one or more alternative embodiments. FIG. 25 is the same as FIG. 23 except that in FIG. 25, the DI controller 2070 has an additional input coupled to a flow meter 2010 FM1. The flow meter 2010 FM1 can provide additional sensitivity and/or accuracy for low and high flow rates compared to the embodiment shown in FIG. 23. The DI controller can control pumps 2000 P3, P4 based on or based in part on the flow rate of the residual herbicide(s) (e.g., the first herbicide mixture) into the mixing tank 1920 as measured by flow meter 2010 FM1. The pumps 2000 P3, P4 are not sensitive to line pressure such that they can feed the mixing tank 1920.

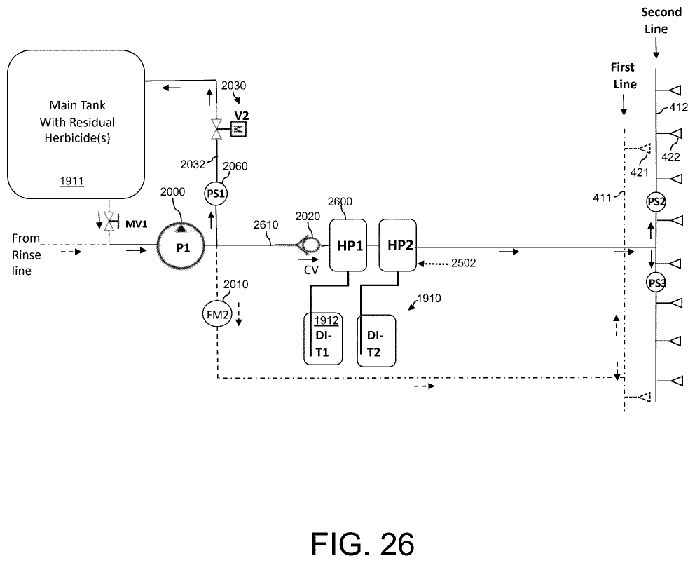

FIG. 26 is a detailed block diagram of the fluid and electrical circuits shown in FIG. 19 according to one or more alternative embodiments. In FIG. 26, the reservoir tank 1920 is removed and hydraulic pumps 2600 HP1, HP2 are fluidly coupled to the respective non-residual herbicide tanks 1912 and to a fluid line 2610 that holds the residual herbicide(s) from the residual tank 1911. The hydraulic pumps 2600 HP1, HP2 inject the respective non-residual herbicide(s) held in the respective non-residual herbicide tanks 1912 into the fluid line 2610, for example by suctioning from the non-residual herbicide tanks 1912 relative to the flow rate of residual herbicide(s) (e.g., the first herbicide mixture) through the fluid line 2610. Each hydraulic pump 2600 HP1, HP2 can have a respective dose calibration 2502 for its mechanical-electrical components to provide the appropriate volume of non-residual herbicide(s) so to achieve a predetermined concentration and/or ratio of non-residual herbicide(s) in the herbicidal mixture (e.g., the second herbicide mixture) formed in the fluid line 2610.

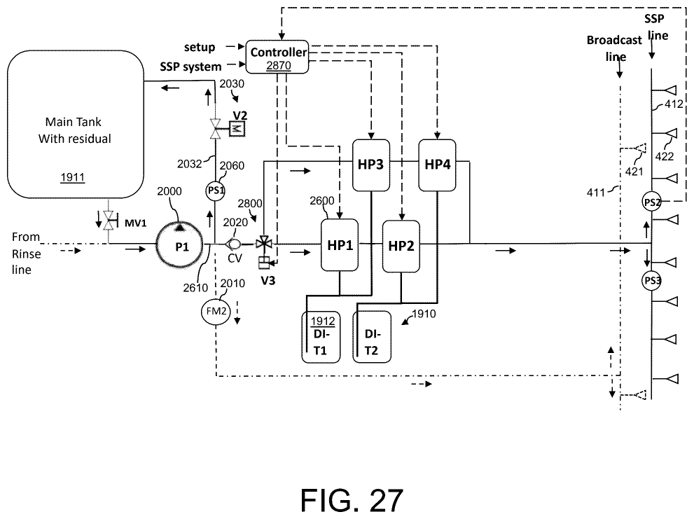

FIG. 27 is a detailed block diagram of the fluid and electrical circuits shown in FIG. 19 according to one or more alternative embodiments. FIG. 27 is the same as FIG. 26 except that FIG. 27 includes hydraulic pumps 2600 HP3, HP4, a controller 2870, and a 3-way valve 2800. The 3-way valve 2800 has a first state in which the residual herbicide(s) in the fluid line 2610 flow through a first set of hydraulic pumps 2600 HP1, HP2 and a second state in which the residual herbicide(s) in the fluid line 2610 flow through a second set of hydraulic pumps 2600 HP3, HP4. The first set of hydraulic pumps HP1, HP2 can be configured and/or sized for high accuracy at high flow rates and/or at high pressures. The second set of hydraulic pumps HP3, HP4 can be configured and/or sized for high accuracy at low flow rates and/or at low pressures. Hydraulic pumps 2600 HP1 and HP3 are fluidly coupled to the first non-residual herbicide tank (DI-T1) 1912. Hydraulic pumps 2600 HP2 and HP4 are fluidly coupled to the second non-residual herbicide tank (DI-T2) 1912. Each hydraulic pump 2600 HP1-HP4 can have a respective dose calibration for its mechanical-electrical components to provide the appropriate volume of non-residual herbicide(s) (e.g., the first herbicide mixture) so to achieve a predetermined concentration and/or ratio of non-residual herbicide(s) in the herbicidal mixture (e.g., the second herbicide mixture) formed in the fluid line 2610.

The pressure measured by pressure sensor 2060 PS2 on the SSP line 412 can be used by the controller 2870 to determine the state of the 3-way valve 2800. The controller 2870 can cause the 3-way valve 2800 to transition to the first state when the pressure measured by the pressure sensor 2060 PS2 is higher than a predetermined threshold pressure such that the first set of hydraulic pumps 2600 HP1, HP2 is activated to improve accuracy at high pressures/flow rates. The controller 2870 can cause the 3-way valve 2800 to transition to the second state when the pressure measured by the pressure sensor 2060 PS2 is lower than the predetermined threshold pressure such that the second set of hydraulic pumps 2600 HP3, HP4 is activated to improve accuracy at low pressures/flow rates.

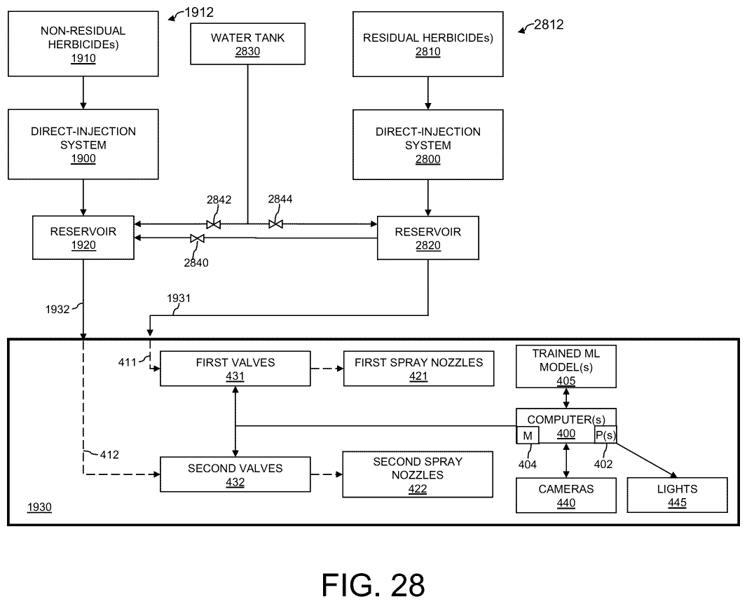

FIG. 28 is a simplified block diagram of fluid and electrical circuits for a sprayer system 10, 20, 30 according to one or more alternative embodiments. A control system similar to those shown in FIGS. 20-27 can be used for the sprayer system shown in FIG. 28. FIG. 28 can be the same as FIG. 19 except as described herein. A first direct-injection system 1900 has an input that is fluidly coupled to a first container 1912 that holds the one or more non-residual herbicides 1910. The first direct-injection system 1910 is configured to inject or introduce the one or more non-residual herbicides 1910 into water from a water tank 2830, which is provided as a first input to a first reservoir tank 1920. Direct injecting the non-residual herbicide(s) 1910 into the water produces a first liquid that includes the non-residual herbicide(s) 1910 such that a concentration of non-residual herbicide(s) 1910 in the first liquid is at a first target level. The first liquid is stored in a first reservoir tank 1920.

A second direct-injection system 2800 has an input that is fluidly coupled to a second container or tank 2812 that holds the one or more residual herbicides 2810. The second direct-injection system 2800 is configured to inject or introduce the one or more residual herbicides 2810 into water from the water tank 2830, which is provided as a first input to a second reservoir tank 2820. Direct injecting the residual herbicide(s) 2810 into the water produces a second liquid that includes the non-residual herbicide(s) 1910 such that a concentration of residual herbicide(s) 2810 in the second liquid is at a second target level. The second liquid can be the same as the first herbicide mixture in one or more embodiments.

The first reservoir tank 1920 has a second input that is fluidly coupled to an output of the second reservoir tank 2820 to receive the second liquid. Alternatively, the second input of the first reservoir tank 1920 can be fluidly coupled to an output of the second direct-injection system 2800 to receive the second liquid. The second liquid, the water, and the one or more non-residual herbicides 1910 are mixed in the first reservoir tank 1920 to produce a mixture of non-residual herbicide(s) 1910 and residual herbicide(s) 2810. The mixture of non-residual herbicide(s) 1910 and residual herbicide(s) 2810 can be the same as the second herbicide mixture in one or more embodiments. A valve 2840 can adjustably control the volume of the second liquid flowing into the first reservoir 1920 to adjust a concentration, a volume, and/or a ratio of residual herbicide(s) 2810 and/or a concentration, a volume, and/or a ratio of non-residual herbicide(s) 1910 in the herbicide mixture (e.g., the second herbicide mixture) stored in the first reservoir tank 1920. Valves 2842, 2844 can adjustably control the volume of water flowing into the first and second reservoir tanks 1920, 2820, respectively.

The second reservoir tank 2820 can be sized to store a sufficient volume of the second liquid (e.g., the first herbicide mixture) to be used (e.g., on average) by the first spray nozzles 421. For example, when the first spray nozzles 421 are activated for about 90% of the time (on average), the volume of the second reservoir tank 2820 can be about 90% of the volume of a residual herbicide tank 1911 (FIG. 19). In another example, when the first spray nozzles 421 are activated for about 90% of the time (on average), the volume of the second reservoir tank 2820 can be about 9 times the volume of the first reservoir tank 1920. The second reservoir tank 2820 can have other volumes in other embodiments. Additionally or alternatively, the second reservoir tank 2820 can be configured to allow the second direct-injection system 2800 to run continuously.

The first and/or second tanks 1920, 2820 can be pressurized such that the first and/or second tanks 1920, 2820 can function as respective pressurized mixing tank(s). Alternatively, the first and/or second tanks 1920, 2820 can be unpressurized (e.g., operating at atmospheric pressure) and a respective pump can be included downstream of the first and/or second tanks 1920, 2820. The second fluid line(s) 412 on the spray boom 1930 is/are fluidly coupled to the first reservoir tank 1920 by one or more fluid lines 1932. The second fluid line(s) 411 on the spray boom 1930 is/are fluidly coupled to the second reservoir tank 2820 by one or more fluid lines 1931.

In one or more embodiments, the water tank 2830 can be a spray tank (e.g., a first tank 111 or a second tank 112) that is filled with an herbicidal mixture instead of water. Additionally or alternatively, the water in the water tank 2830 can include one or more agricultural additives such as fertilizer and/or nutrients to apply to an agricultural field.

The second spray nozzles 422 are fluidly coupled to the first reservoir tank 1920 (e.g., via respective second valves 432) to spray the first liquid (e.g., the second herbicide mixture). The first nozzles 421 are fluidly coupled to the second reservoir tank 2820 (e.g., via respective first valves 431) to spray the second liquid (e.g., the first herbicide mixture).

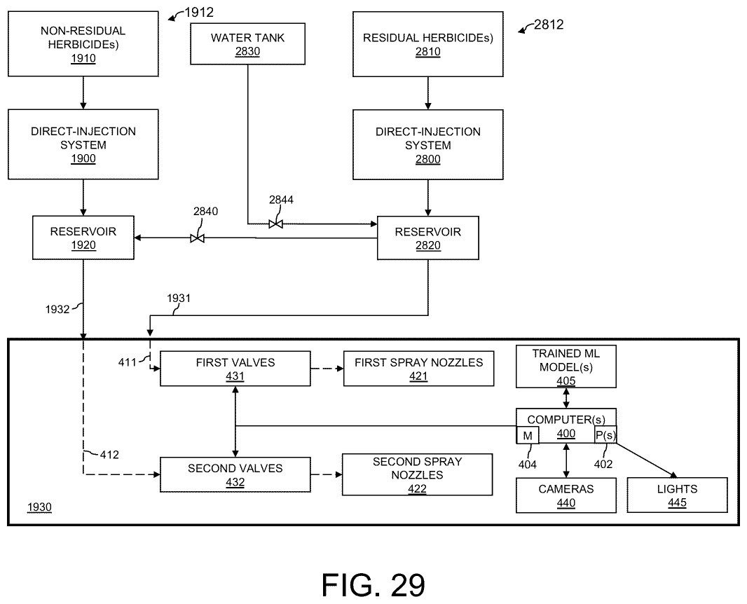

FIG. 29 is a simplified block diagram of fluid and electrical circuits for an agricultural spray system 10, 20, 30 according to one or more alternative embodiments. FIG. 29 can be the same as FIGS. 19 and/or 28 except as described herein. In FIG. 29, the water tank 2830 is only fluidly coupled to the second reservoir tank 2820. The second liquid with the residual herbicide(s) 2810 is output from the second reservoir tank 2820 and input to the first reservoir tank 1920. In the first reservoir tank 1920, the first direct-injection system 1910 injects or introduces one or more non-residual herbicides 1910 into the second liquid (e.g., the first herbicide mixture) to produce an herbicide mixture (e.g., the second herbicide mixture) that includes the non-residual herbicide(s) 1910 and the residual herbicide(s) 2810.

A valve 2840 can control the volume of the second liquid flowing into the first reservoir 1920 to adjust a concentration, a volume, and/or a ratio of residual herbicide(s) 2810 and/or a concentration, a volume, and/or a ratio of non-residual herbicide(s) 1910 in the herbicide mixture (e.g., the second herbicide mixture) stored in the first reservoir tank 1920. A valve 2844 can adjustably control the volume of water flowing into the second reservoir tank 2820.

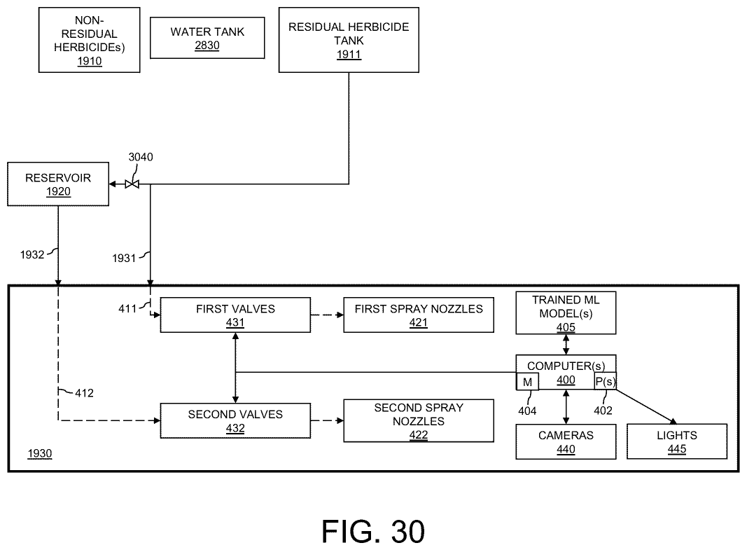

FIG. 30 is a simplified block diagram of fluid and electrical circuits for an agricultural spray system 10, 20, 30 according to one or more alternative embodiments. FIG. 30 is the same as FIG. 19 except that FIG. 30 does not include a direct-injection system 1900. Instead, the reservoir tank 1920 can be manually filled (e.g., periodically or at other times or intervals) with either a mixture of (a) water (e.g., from a water tank 2830 or another water source) and non-residual herbicide(s) 1910 and/or (b) residual herbicide(s) from the residual herbicide tank 1911 (e.g., the first herbicide mixture) and non-residual herbicide(s) 1910. When the reservoir tank 1920 includes residual herbicide(s) from the broadcast tank 111) and non-residual herbicide(s) 1910, the reservoir tank 1920 holds an herbicide mixture (e.g., the second herbicide mixture) that includes the non-residual herbicide(s) 1910 and the residual herbicide(s).

A valve 3040 can control the volume of the residual herbicide(s) from the residual herbicide tank 1911 to adjust a concentration, a volume, and/or a ratio of residual herbicide(s) from the residual herbicide tank 1911 and/or a concentration, a volume, and/or a ratio of non-residual herbicide(s) 1910 in the herbicide mixture stored in the reservoir tank 1920.

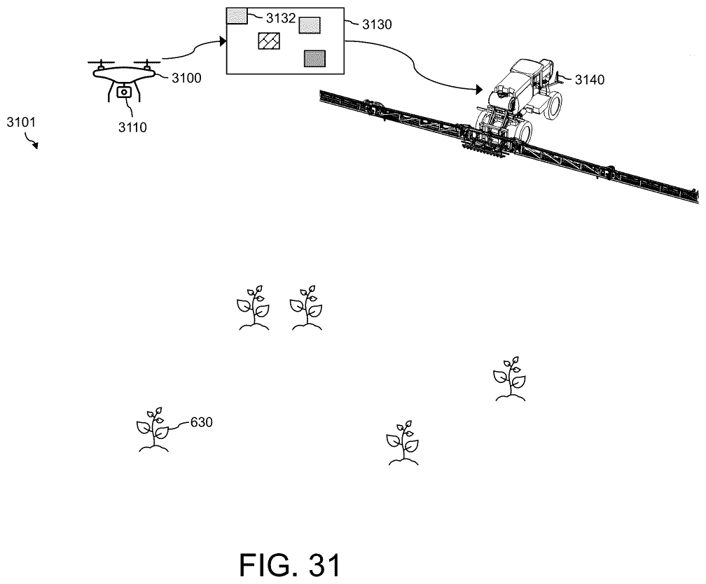

FIG. 31 is a simplified illustration of a drone 3100 flying over an agricultural field 3101. The drone 3100 captures high-resolution images of the agricultural field 3101 using one or more on-board cameras 3110. The drone 3100 can include global positioning system (GPS) circuitry that allows the geospatial position of the drone 3100 and of the agricultural-field regions captured in the images to be determined. The images can be fed into a trained ML model (e.g., trained ML model 314A, 405) to detect target weeds 630 and/or to determine the weed density of the agricultural field 3101.

The drone 3100 can process the image data and/or the output of the trained ML model to produce a prescription map 3130 that includes the GPS coordinates of each detected weed 630 and varying weed densities 3132 of respective agricultural-field regions. This map can be created using geographic information systems (GIS) software or specialized agricultural software that can output a map compatible with an ISOBUS task controller (e.g., compatible with ISO 11783-1: 2017 Tractors and machinery for agriculture and forestry—Serial control and communications data network). The prescription map 3130 can alternately be referred to as a weed map or a weed density map.

The prescription map 3130 can be sent to a sprayer system 3140 such as through wired or wireless communication. In some embodiments, the drone 3100 can send the prescription map 3130 to a computer, such as a server, that can then send the prescription map 3130 to the sprayer system 3140 directly or through one or more intermediate servers, routers, and/or other network components. The sprayer system 3140 can be the same as the sprayer system 10, 20, or 30.

The sprayer system 3140 can include a task controller that can interpret the prescription map 3130 and produce instructions for spraying the agricultural field 3101 based, at least in part, on the prescription map 3130. The instructions can include (a) areas where increased spraying (e.g., up to 4 times the default amount) is required (e.g., spraying can be increased in regions with higher weed densities 3132) and (b) activation of specific nozzles (e.g., first spray nozzles 421 and/or second nozzles 422) based on the map's data. The instructions produced by the task controller can be sent to the control system of the sprayer system 3140.

The task controller and/or the control system of the sprayer system 3140 can adjust the duty cycle (e.g., PWM settings) of the valves for the respective activated nozzles to vary the spray rate of herbicide. In regions with lower weed densities 3132 (e.g., below a threshold weed density), a lower or default duty cycle of the valves for the respective activated nozzles can be used to apply a lower/baseline spray rate. In regions with higher weed densities 3132 (e.g., above or equal to the threshold weed density), an increased duty cycle of the valves for the respective activated nozzles can be used to apply an increased spray rate, which can be up to 4 times the lower/baseline spray rate.

In regions with lower weed densities 3132, the appropriate second spray nozzle(s) 422 is/are selectively activated to apply specific liquid herbicides (e.g., one or more non-residual herbicides or a mixture of residual and non-residual herbicides such as the second herbicide mixture) onto the target weeds and the broadcast nozzle(s) is/are selectively deactivated such that only the second spray nozzle(s) 422 spray the target spray regions that include target weeds and only the first spray nozzles 421 spray the target spray regions that do not include target weeds. The duty cycle of the activated second spray nozzle(s) 422 and the activated first spray nozzle(s) 421 can be set at a lower/default value to apply a lower/default spray rate to the respective spray regions.

In regions with higher weed densities 3132, the appropriate second spray nozzle(s) 422 and the appropriate first spray nozzle(s) 421 can be activated to apply both non-residual herbicide(s) (or the second herbicide mixture) and residual herbicides (e.g., the first herbicide mixture), respectively, onto the target spray regions that include target weeds. The duty cycle of the activated second spray nozzle(s) 422 and/or of the activated first spray nozzle(s) 421 can be increased (e.g., by up to times the lower/baseline rate) to apply an increased spray rate (e.g., up to 4 times the lower/baseline spray rate) to the target spray regions. Alternatively, only the second spray nozzle(s) 422 can be activated to spray the target spray regions with higher weed densities 3132. The duty cycle of the activated second spray nozzle(s) 422 can be increased, as discussed, relative to a lower/baseline duty cycle to increase the spray rate of the non-residual herbicide(s) (or the second herbicide mixture).

The task controller and/or the control system of the sprayer system 3140 ensures that the correct nozzles are activated at the right time and place and using the correct duty cycle.

In some embodiments, the sprayer system 3140 does not capture images of the agricultural field to detect weeds (and/or other target features). In other embodiments, the sprayer system 3140 captures images of the agricultural field to detect weeds, for example to confirm the data from the prescription map 3130 and/or to register the prescription map 3130 with the GPS coordinates of the sprayer system 3140.

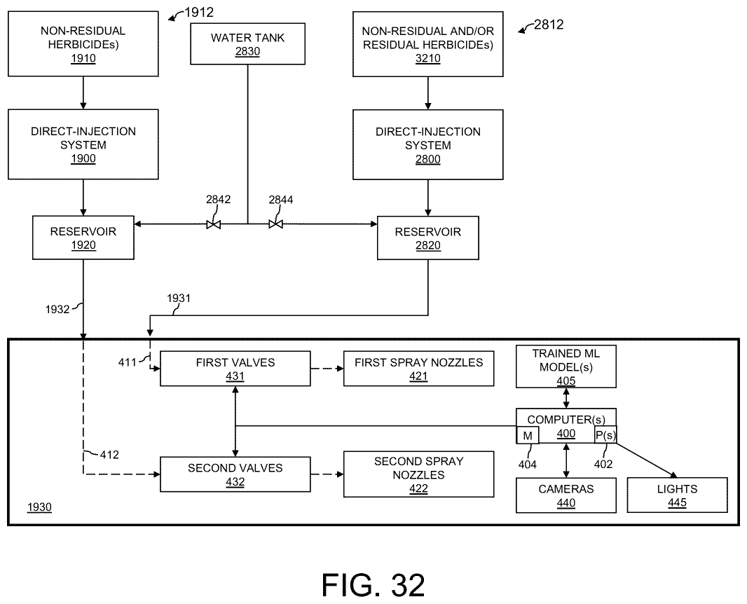

FIG. 32 is a simplified block diagram of fluid and electrical circuits for an agricultural spray system 10, 20, 30 according to one or more alternative embodiments. FIG. 32 is the same as FIG. 29 except as described herein. In FIG. 32, the first and second reservoir tanks 1920, 2820 are fluidly coupled to the water tank 2830 but the first and second reservoir tanks 1920, 2820 are not fluidly coupled to each other. In addition, the second container or tank 2812 holds one or more non-residual and/or one or more residual herbicides 3210.

Direct injecting the one or more non-residual herbicide(s) 1910 (e.g., first non-residual herbicide(s)) into the water produces a first liquid that includes the non-residual residual herbicide(s) 1910 such that a concentration of non-residual herbicide(s) 1910 in the first liquid is at a first target level. The first liquid can the same as the first herbicide mixture. Direct injecting the non-residual and/or one or more residual herbicide(s) 3210 into the water produces a second liquid that includes the non-residual and/or one or more residual herbicide(s) 3210 such that a concentration of non-residual and/or residual herbicide(s) 3210 in the second liquid is at a second target level.

The second spray nozzles 422 are fluidly coupled to the first reservoir tank 1920 (e.g., via respective second valves 432) to spray the first liquid. The first spray nozzles 421 are fluidly coupled to the second reservoir tank 2820 (e.g., via respective first valves 431) to spray the second liquid.

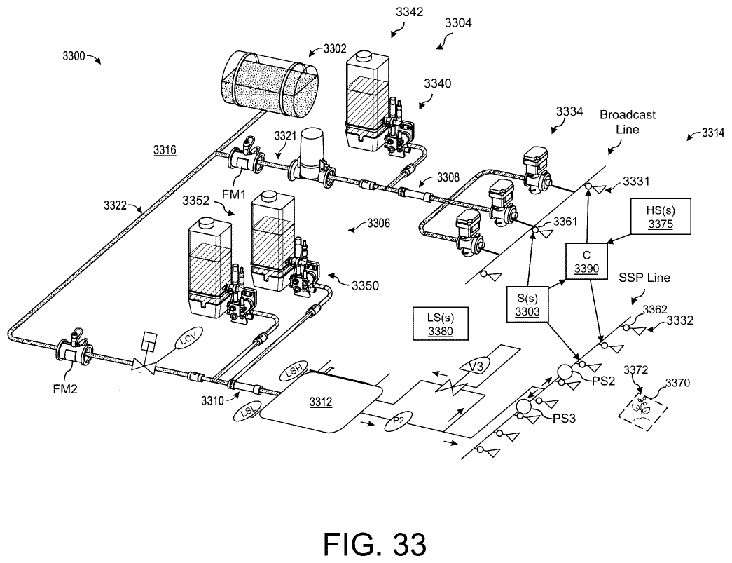

FIG. 33 shows an agricultural sprayer system 3300 according to one or more embodiments. The sprayer system 3300 includes a tank 3302, a first direct-injection system 3304, a second direct-injection system 3306, a first in-line mixer 3308, a second in-line mixer 3310, a buffer/reservoir/mixing tank 3312, and a spray boom 3314. The spray boom 3314 includes broadcast nozzles 3331 and SSP nozzles 3332. The tank 3302, the first direct-injection system 3304, the second direct-injection system 3306, the first in-line mixer 3308, the second in-line mixer 3310, and/or the buffer/reservoir/mixing tank 3312 can be mounted and/or disposed on an agricultural vehicle 3316.

The tank 3302 holds a volume of liquid such as water. In one or more embodiments, the tank 3302 comprises a water tank that holds a volume of water. In other embodiments, the tank 3302 can hold a combination (e.g., mixture, suspension, etc.) of water and another substance. For example, the combination can an agricultural material such as a fertilizer, nutrients and/or other substances/materials. The water can be replaced with or can include another liquid in some embodiments.

First and second fluid lines 3321, 3322 are fluidly coupled to an output of the tank 3302 to receive the liquid. The flow rate of the liquid in the first and second fluid lines 3321, 3322 can be measured by flow meters FM1, FM2, respectively. The first direct-injection system 3304 is configured to inject one or more residual herbicides into the first fluid line 3321 to form a residual herbicide mixture. The first direct-injection system 3304 includes at least a pump 3340 (e.g., an injection pump or a direct-injection pump) and a vessel or container 3342 that stores the residual herbicide(s).

The first direct-injection system 3304 can be controlled (e.g., by flow rate and/or pressure) such that a concentration of residual herbicide(s) in the residual herbicide mixture is at a first target level. In one or more embodiments, a plurality of first direct-injection systems (e.g., each a first direct-injection system 3304) can inject one or more respective residual herbicides into the first fluid line 3321. Each first direct-injection system can be controlled (e.g., by a respective flow rate and/or respective pressure) such that a concentration of each residual herbicide(s) in the residual herbicide mixture is at a respective first target level.

The second direct-injection system 3306 is configured to inject one or more non-residual herbicides into the second fluid line 3322 to form a non-residual herbicide mixture. The second direct-injection system 3306 includes at least a pump 3350 (e.g., an injection pump or a direct-injection pump) and a vessel or container 3352 that stores the non-residual herbicide(s). Two direct-injection systems 3306 are shown in FIG. 33, but there can be one direct-injection system 3306 or more than two direct-injection systems 3306 in other embodiments.

The second direct-injection system 3306 can be controlled (e.g., by flow rate and/or pressure) such that a concentration of non-residual herbicide(s) in the non-residual herbicide mixture is at a second target level. In one or more embodiments, a plurality of second direct-injection systems (e.g., each a second direct-injection system 3306) can inject one or more respective non-residual herbicides into the second fluid line 3322. Each second direct-injection system can be controlled (e.g., by a respective flow rate) such that a concentration of each non-residual herbicide(s) in the non-residual herbicide mixture is at a respective second target level.

The first and second in-line mixers 3308, 3310 have a respective internal volume and/or geometry that can promote the mixing of the liquid and the residual and non-residual herbicides, respectively, to produce the residual and non-residual herbicide mixtures, respectively. The buffer/reservoir/mixing tank 3312 can be configured and/or sized to store a sufficient volume of the non-residual herbicide mixture (e.g., liquid and the non-residual herbicide(s)) to be used (e.g., on average) by the SSP nozzles 3332 on the spray boom 3314.

A plurality of broadcast nozzles 3331 are fluidly coupled (e.g., via respective broadcast valves 3361, one or more broadcast lines, and/or one or more section valves 3334) to the first fluid line 3321 to receive the first liquid mixture. The SSP nozzles 3332 are fluidly coupled (e.g., via respective SSP valves 3362 and one or more SSP lines) to the second fluid line 3322 to receive the residual herbicide mixture.

The broadcast nozzles 3331 and the SSP nozzles 3332 can be spatially arranged in various configurations. In one or more embodiments, the respective spray areas of the broadcast nozzles 3331 and the SSP nozzles 3332 are spatially aligned partially or fully, for example, as described herein with respect to the first and second spray nozzles 421, 422, respectively. In other embodiments, only some (or none) of the respective spray areas of the broadcast nozzles 3331 and the SSP nozzles 3332 can be spatially aligned partially or fully, while others of the respective spray areas of the broadcast nozzles 3331 and the SSP nozzles 3332 can be not spatially aligned. The broadcast nozzles 3331 can be spaced along the spray boom 3314 to provide a substantially uniform application of the first liquid mixture across the spray boom 3314.

In operation, in one or more embodiments the broadcast nozzles 3331 can be configured to spray in broadcast mode where the broadcast nozzles 3331 spray the agricultural field continuously or substantially continuously (e.g., at a frequency and duty cycle that can be variable) as the spray boom 3314 moves across the agricultural field. The broadcast nozzles 3331 can apply the residual herbicide mixture at a uniform or substantially uniform application rate across some or all of the length of the spray boom 3314. One or more SSP nozzles 3332 selectively sprays the non-residual herbicide mixture onto respective region(s) (e.g., coverage area(s) 3370) of the agricultural field when weed(s) 3372 is/are detected in the respective region(s). The SSP nozzles 3332 can selectively spray at a frequency and duty cycle that can be variable. Weeds can be detected by one or more sensors 3303 disposed or mounted on the spray boom 3314.

The buffer/reservoir/mixing tank 3312 is configured to hold a predetermined volume of the non-residual herbicide mixture that is sufficient to allow for a variable flow rate of the non-residual herbicide mixture within the SSP line(s). For example, the flow rate of the non-residual herbicide mixture will be higher when weeds 3372 are detected in multiple coverage areas 3370 such that multiple SSP valves 3362 and respective SSP nozzles 3332 are opened/activated to spray the non-residual herbicide mixture onto those coverage areas 3370. Likewise, the flow rate of the non-residual herbicide mixture will be lower when no or few weeds 3372 are detected such only one or a few SSP valves 3362 and respective SSP nozzles 3332 is/are opened/activated to spray the non-residual herbicide mixture onto those coverage areas 3370. In one or more embodiments, the predetermined volume can correspond to an average volume sprayed by the SSP nozzles 3332. For example, when weeds are detected on average in 40% of the coverage areas 3370, the predetermined volume can be equal to and/nor can correspond to 40% of the total spray capacity of the SSP nozzles 3332 (e.g., when all SSP valves 3362 and respective SSP nozzles 3332 spray simultaneously or substantially simultaneously).

The sensor(s) 3303 is/are configured to detect, in a particular coverage area 3370, the presence or absence of one or more weeds 3372 (e.g., one or more target weeds 630). The sensor(s) 3303 can comprise image sensor(s) and/or light sensors (e.g., near-infrared light sensor(s), fluorescent sensor(s), cameras, and/or other light sensor(s)). The sensor(s) 3303 can detect weeds using natural light and/or artificial light produced by one or more light sources 3380. The light source(s) 3380 can be oriented to illuminate the agricultural field in the direction of travel of the agricultural vehicle 3316 and/or in alignment with the sensor(s) 3303.

In one or more embodiments, the light source(s) 3380 is/are configured to produce pulsed red and/or blue lights using LEDs and the sensor(s) 3303 can be configured to detect the amount of light reflected back (e.g., using photodiodes and/or other sensors) from the agricultural field. Plants, such as weeds, containing chlorophyll absorb the red light, reflecting less of it, whereas bare soil or crop residue reflects more red light. The sensor(s) 3303 can sample (e.g., continuously sample) reflectance data as the spray boom 3314 moves across the agricultural field. When the amount of reflected red light drops below a predetermined threshold value (indicating chlorophyll absorption), indicating the presence of a green plant (e.g., one or more weeds), a respective sensor 3303 and/or a controller 3390 sends a control signal to open one or more respective SSP valves 3362 and triggers one or more respective SSP nozzles 3332 to spray the non-residual herbicide mixture onto the coverage area 3370 where the weed(s) 3372 is/are detected. The predetermined threshold value is set to distinguish weeds from soil or crop residue based on field conditions and can be adjusted depending on the sensitivity needed for specific environments.

In one or more embodiments, the light source(s) 3380 is/are configured to produce red and near-infrared (NIR) light simultaneously. The reflected signals are captured by the sensor(s) 3303, and the sensor(s) 3303 and/or the controller 3390 calculates a ratio of the absorption of red light to the reflectance of NIR light. Plants, such as weeds, reflect more NIR and absorb more red light due to chlorophyll, while soil reflects both wavelengths more evenly. The ratio can be the same as or similar to the Normalized Difference Vegetation Index (NDVI) ratio. When the calculated ratio exceeds a predetermined threshold ratio (e.g., indicating the distinct spectral signature of green vegetation), the sensor(s) 3303 and/or the controller 3390 determines that one or more weeds is/are detected and sends a command to open one or more respective SSP valves 3362 and triggers one or more respective SSP nozzles 3332 to spray the non-residual herbicide mixture onto the coverage area 3370 where the weed(s) 3372 is/are detected. This decision-making process happens in milliseconds, allowing real-time, spot-spray precision.

The controller 3390 can be optional in one or more embodiments. When the controller 3390 is included, the controller 3390 is operably coupled to the sensor(s) 3303. For example, the controller 3390 can be in wired and/or in wireless communication with the sensor(s) 3303. The controller 3390 is configured to receive output data from the sensor(s) 3303 that represents a presence or an absence of weeds 3372 in a given coverage area 3370. When the output data from one or more respective sensors 3303 indicates that at least one weed 3372 is detected in a given coverage area 3370 or the output data from the respective sensor(s) 3303 is inconclusive, the controller 3390 automatically open at least one SSP valve 3362 to cause at least one respective SSP nozzle 3332 to spray the non-residual herbicide mixture onto that coverage area 3370. When the output data from the respective sensor(s) 3303 indicates that no weeds 3372 are detected in a given coverage area 3370, the controller 3390 closes (and/or does not open) causes at least one SSP valve 3362 to prevent, inhibit, or refrain the at least one respective SSP nozzle 3332 from spraying spray the non-residual herbicide mixture onto that coverage area 3370.

The SSP valves 3362 can have default closed states such that control signals, from the sensor(s) 3303 and/or controller 3390, are only required to open a given SSP valve 3362. Alternatively, the sensor(s) 3303 and/or controller 3390 can send control signals to close a given SSP valve 3362.

In one or more embodiments, one or more height sensors 3375 can be disposed on the spray boom 3314. The height sensor(s) 3375 can measure the height of the spray boom 3314, the height of the SSP valves 3362, and/or the height of the SSP nozzles 3332.

In one or more examples, the sensor(s) 3303 and/or the controller 3390 includes and/or is/are coupled to a trained machine-learning detection device that is configured to distinguish target weeds (e.g., weed 3372) from background crops and/or soil. The trained machine-learning detection device can comprise a trained machine-learning model running on a computer or processor. The trained machine-learning model can be the same as the trained ML model(s) 405. The trained machine-learning detection device and/or the trained machine-learning model can be trained with images that contain examples of target weeds and images that do not contain the target weeds.

In one or more examples, the system 3300 can include a plurality of controllers 3390 and a plurality of sensors 3303 where each sensor 3303 (or one or more sensors 3303) is operatively coupled to a respective controller 3390. Each controller 3390 can control a respective subset or group of the broadcast and SSP valves 3361, 3362. Each sensor 3303 can be associated with and/or configured to detect weeds in a respective one or more coverage areas 3370.

The output data from a sensor 3303 may be inconclusive when (i) a height of the SSP spray nozzles 3332, a height of SSP valves 3362, and/or a height of the spray boom 3314, as measured by the height sensor(s) 3375, is/are outside of a respective predetermined height range for operation, (ii) one or more environmental factors (e.g., precipitation, fog, smoke, temperature, and/or wind) prevent accurate weed detection, (iii) there are insufficient illumination conditions (e.g., artificial illumination from one or more light sources and/or natural illumination such as from the sun) for the sensor(s) 3303 (e.g., illumination below a predetermined threshold value), and/or (iv) there is/are a malfunction of and/or a communication failure of the sensor(s) 3303 (e.g., a communication failure between the sensor(s) 3304 and the controller 3304 and/or a communication failure between the sensor(s) 3304 and one or more SSP valves 3362).

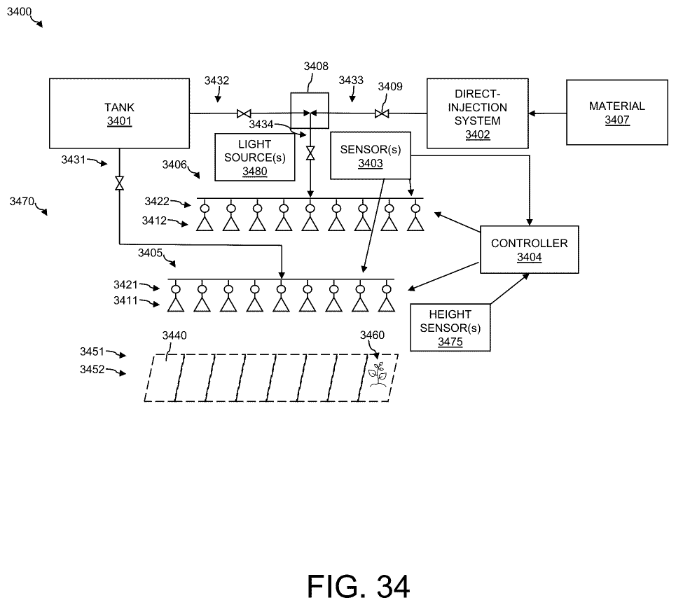

FIG. 34 is a block diagram of a system 3400 for selectively spraying an agricultural field according to one or more embodiments. The system 3400 includes a tank 3401, a direct-injection system 3402, one or more sensors 3403, a controller 3404, a first valve system 3405, and a second valve system 3406.

The tank 3401 can hold and/or store an herbicidal mixture. The herbicidal mixture can include one or more residual herbicides. The herbicidal mixture can be the same as the first herbicide mixture and/or the residual herbicide mixture described herein. Additionally or alternatively, the herbicidal mixture can include one or more non-residual herbicides.

The tank 3401 is fluidly coupled to first and second output lines 3431, 3432. The first output line 3431 is fluidly coupled to an input of the first valve system 3405. The second output line 3432 is fluidly coupled to an output line 3433 of the direct-injection system 3402. The direct-injection system 3402 injects and/or introduces a material 3407 through the output line 3433 such that an input line 3434 to the second valve system 3406 includes a mixture comprising the herbicidal mixture (e.g., from the tank 3401) and the material 3407 (e.g., injected/introduced by the direct-injection system 3402). In one or more embodiments, the output lines 3432, 3433 and the input line 3434 are fluidly coupled to a mixing tank 3408 where the mixture comprising the herbicidal mixture and the material 3407 can be formed and/or stored. One or more valves 3409 can be fluidly coupled to the lines 3431, 3432, 3433, and/or 3434 to control the flow of liquid in the respective line. In one or more embodiments, the material 3407 injected/introduced by the direct-injection system 3402 is or includes at least one non-residual herbicide.

The first valve system 3405 includes a plurality of first nozzles 3411. Each first nozzle 3411 is configured to spray the herbicidal mixture onto at least one coverage area 3440 (e.g., onto at least one respective coverage area 3440). Collectively, the first nozzles 3411 are configured to spray the herbicidal mixture onto a first set of coverage areas 3451. The first set of coverage areas 3451 can be defined by and/or can correspond to the coverage areas 3440.

The second valve system 3406 includes a plurality of second nozzles 3412. Each second nozzle 3412 is configured to spray the mixture comprising the herbicidal mixture and the material 3407 onto at least one coverage area 3440 (e.g., onto at least one respective coverage area 3440). Collectively, the second nozzles 3412 are configured to spray the mixture comprising the herbicidal mixture and the material 3407 onto a second set of coverage areas 3452. The second set of coverage areas 3452 can be defined by and/or can correspond to the coverage areas 3440. The second set of coverage areas 3452 covers the same or substantially the same area (e.g., having less than or equal to about a 10% difference in area) as the first set of coverage areas 3451. Thus, a given coverage area 3440 can be spayed by either one or more first nozzles 3411 or one or more second nozzles 3412.

The sensor(s) 3403 is/are configured to detect, for each coverage area 3440, the presence or absence of one or more weeds 3460 (e.g., one or more target weeds 630). The sensor(s) 3403 can comprise image sensor(s) and/or light sensors (e.g., near-infrared light sensor(s), fluorescent sensor(s), cameras, and/or other light sensor(s)). The sensor(s) 3403 can detect weeds using natural light and/or artificial light produced by one or more light sources 3480. The light source(s) 3480 can be mounted on a spray boom 3470. The light source(s) 3480 can be oriented to illuminate the agricultural field in the direction of travel of the spray boom 3470 and/or in alignment with the sensor(s) 3403.

In one or more embodiments, the light source(s) 3480 is/are configured to produce pulsed red and/or blue lights using LEDs and the sensor(s) 3403 can be configured to detect the amount of light reflected back (e.g., using photodiodes and/or other sensors) from the agricultural field. Plants, such as weeds, containing chlorophyll absorb the red light, reflecting less of it, whereas bare soil or crop residue reflects more red light. The sensor(s) 3403 can sample (e.g., continuously sample) reflectance data as the spray boom 3470 moves across the agricultural field. When the amount of reflected red light drops below a predetermined threshold value (indicating chlorophyll absorption), indicating the presence of a green plant (e.g., one or more weeds), a respective sensor 3403 and/or the controller 3404 sends a control signal to open one or more respective second valves 3422 and triggers one or more respective second nozzles 3412 to spray the mixture comprising the herbicidal mixture and the material 3407 onto the coverage area 3440 where the weed(s) is/are detected. The predetermined threshold value is set to distinguish weeds from soil or crop residue based on field conditions and can be adjusted depending on the sensitivity needed for specific environments.

In one or more embodiments, the light source(s) 3480 is/are configured to produce red and NIR light simultaneously. The reflected signals are captured by the sensor(s) 3403, and the sensor(s) 3403 and/or the controller 3404 calculates a ratio of the absorption of red light to the reflectance of NIR light. Plants, such as weeds, reflect more NIR and absorb more red light due to chlorophyll, while soil reflects both wavelengths more evenly. The ratio can be the same as or similar to the NDVI ratio. When the calculated ratio exceeds a predetermined threshold ratio (e.g., indicating the distinct spectral signature of green vegetation), the sensor(s) 3403 and/or the controller 3404 determines that one or more weeds is/are detected and sends a command to open one or more respective second valves 3422 and triggers one or more respective second nozzles 3412 to spray the mixture comprising the herbicidal mixture and the material 3407 onto the coverage area 3440 where the weed(s) is/are detected. This decision-making process happens in milliseconds, allowing real-time, spot-spray precision.

The controller 3404 is operably coupled to the sensor(s) 3403. For example, the controller 3404 can be in wired and/or in wireless communication with the sensor(s) 3403. The controller 3404 is configured to receive output data from the sensor(s) 3403 that represents a presence or an absence of weeds 3460 in each coverage area 3440. When the output data from one or more respective sensors 3403 indicates that at least one weed 3460 is detected in a given coverage area 3440 or the output data from the respective sensor(s) 3403 is inconclusive, the controller 3404 automatically causes at least one second nozzle 3412 to spray the mixture comprising the herbicidal mixture and the material 3407 onto that coverage area 3440. When the output data from the respective sensor(s) 3403 indicates that no weeds 3460 are detected in a given coverage area 3440, the controller 3404 automatically causes at least one first nozzle 3411 to spray the herbicidal mixture onto that coverage area 3440. Thus, each coverage area 3440 is exclusively sprayed with either the herbicidal mixture by at least one first nozzle 3411 or with the mixture comprising the herbicidal mixture and the material 3407 by at least one second nozzle 3412.

In one or more embodiments, each coverage area 3440 can be sprayed or covered by exactly one first nozzle 3411 from the first valve system 3405 and exactly one second nozzle 3412 from the second valve system 3406. Thus, each coverage area 3440 can be exclusively sprayed with either the herbicidal mixture by only one first nozzle 3411 or with the mixture comprising the herbicidal mixture and the material 3407 by only one second nozzle 3412.

The controller 3404 can cause a given first nozzle 3411 to spray by causing (e.g., by sending control signals to) a respective first valve 3421 to open which can include repeatedly opening and closing the first valve 3421 at a first frequency and at a first duty cycle. The controller 3404 can cause a given second nozzle 3412 to spray by causing (e.g., by sending control signals to) a respective second valve 3422 to open which can include repeatedly opening and closing the second valve 3422 at a second frequency and at a second duty cycle.

The first and second valves 3421, 3422 can have default closed states such that control signals, from the controller 3404, are only required to open a given first valve 3421 and/or to open a given second valve 3422. Alternatively, the controller 3404 can send control signals to the first and second valves 3421, 3422 to close a given first valve 3421 and/or to close a given second valve 3422. For example, when a given first valve 3421 is opened for a respective first nozzle 3411 to spray the herbicidal mixture onto a respective coverage area 3440, one or more respective second valves 3422 are closed such that one or more respective second nozzles 3412 do not spray the mixture comprising the herbicidal mixture and the material 3407 onto the respective coverage area 3440. In another example, when a given second valve 3422 is opened for a respective second nozzle 3412 to spray the herbicidal mixture and the material 3407 onto a respective coverage area 3440, one or more respective first valves 3421 are closed such that one or more respective first nozzles 3411 do not spray the herbicidal mixture onto the respective coverage area 3440.

In one or more embodiments, the first valve system 3405, the second valve system 3406, the sensor(s) 3403, the light source(s) 3480, and/or the controller 3404 can be disposed on and/or mounted on the spray boom 3470. One or more height sensors 3475 can measure the height of the spray boom 3470, the height of the first nozzles 3411, the height of the first valves 3421, the height of the second nozzles 3412, and/or the height of the second valves 3422.

In one or more examples, the herbicidal mixture includes at least one residual herbicide and the material 3407 injected/introduced by the direct-injection system 3402 includes at least one non-residual herbicide. In this example(s), the first nozzles 3411 spray an herbicidal mixture that includes at least one residual herbicide and the second nozzles 3412 spray a mixture at least one residual herbicide and at least one non-residual herbicide (e.g., a mixture of the herbicidal mixture that includes at least one residual herbicide and at least one residual herbicide).

In one or more examples, the sensor(s) 3403 includes and/or is coupled to a trained machine-learning detection device that is configured to distinguish target weeds (e.g., weed 3460) from background crops and/or soil. The trained machine-learning detection device can comprise a trained machine-learning model running on a computer or processor. The trained machine-learning model can be the same as the trained ML model(s) 405. The trained machine-learning detection device and/or the trained machine-learning model can be trained with images that contain examples of target weeds and images that do not contain the target weeds.

In one or more examples, the controller 3404 includes and/or is coupled to a trained machine-learning detection device that is configured to distinguish target weeds (e.g., weed 3460) from background crops and/or soil. The trained machine-learning detection device can comprise a trained machine-learning model running on a computer or processor. The trained machine-learning model can be the same as the trained ML model(s) 405. The trained machine-learning detection device and/or the trained machine-learning model can be trained with images that contain examples of target weeds and images that do not contain the target weeds.

In one or more examples, the system 3400 can include a plurality of controllers 3404 and a plurality of sensors 3403 where each sensor 3403 is operatively coupled to a respective controller 3404. Each controller 3404 can control a respective subset or group of the first and second nozzles 3411, 3412. Each sensor 3403 can be associated with and/or configured to detect weeds in a respective one or more coverage areas 3440.

In one or more alternative embodiments, the herbicidal mixture in the tank 3401 includes one or more non-residual herbicides and the material 3407 injected/introduced by the direct-injection system 3402 includes one or more residual herbicides. When the output data from one or more respective sensors 3403 indicates that at least one weed 3460 is detected in a given coverage area 3440 or the output data from the respective sensor(s) 3403 is inconclusive, the controller 3404 automatically causes at least one first nozzle 3411 to spray the mixture comprising the herbicidal mixture that includes the non-residual herbicides onto that coverage area 3440. When the output data from the respective sensor(s) 3403 indicates that no weeds 3460 are detected in a given coverage area 3440, the controller 3404 automatically causes at least one second nozzle 3412 to spray the mixture of the herbicidal mixture (that includes the non-residual herbicides) and the material 3407 that includes one or more residual herbicides onto that coverage area 3440. Thus, each coverage area 3440 can be exclusively sprayed with either the herbicidal mixture by at least one first nozzle 3411 or with the mixture comprising the herbicidal mixture and the material 3407 by at least one second nozzle 3412.

The output data from a sensor 3403 may be inconclusive when (i) a height of the first spray nozzles 3411, a height of the second spray nozzles 3412, and/or a height of the spray boom 3470, as measured by the height sensor(s) 3475, is/are outside of a respective predetermined height range for operation, (ii) one or more environmental factors (e.g., precipitation, fog, smoke, temperature, and/or wind) prevent accurate weed detection, (iii) there are insufficient illumination conditions (e.g., artificial illumination from one or more light sources and/or natural illumination such as from the sun) for the sensor(s) 3403 (e.g., illumination below a predetermined threshold value), and/or (iv) there is/are a malfunction of and/or a communication failure of the sensor(s) 3403 (e.g., a communication failure between the sensor(s) 3404 and the controller 3404 and/or a communication failure between the sensor(s) and one or more valves 3421, 3422).

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A system for selectively spraying an agricultural field, the system comprising:
(a) a tank containing an herbicidal mixture;
(b) a first valve system fluidly connected to the tank, the first valve system including a plurality of first nozzles, each first nozzle configured to spray the herbicidal mixture onto at least one coverage area of the agricultural field such that the plurality of first nozzles is configured to spray the herbicidal mixture onto a set of coverage areas;
(c) a direct injection system;
(d) a second valve system fluidly connected to the tank and to the direct injection system, the second valve system including a plurality of second nozzles, each second nozzle configured to spray a mixture comprising the herbicidal mixture from the tank and at least one additional material injected by the direct injection system, wherein the plurality of second nozzles collectively covers substantially the same set of coverage areas as the plurality of first nozzles such that each coverage area can be sprayed by at least one of the first nozzles or at least one of the second nozzles;
(e) at least one sensor configured to detect, for each coverage area, a presence or absence of one or more weeds; and
(f) a controller operably coupled to the at least one sensor and configured to:
(i) open at least one second nozzle in the second valve system for a given coverage area when the at least one sensor detects at least one weed in that coverage area or provides an inconclusive indication; and
(ii) open at least one first nozzle in the first valve system for the given coverage area when the at least one sensor does not detect any weed in that coverage area,
wherein each coverage area is sprayed only by one or more first nozzles from the first valve system or by one or more second nozzles from the second valve system, depending on the at least one sensor output for that coverage area.

2. The system of claim 1, wherein the at least one additional material injected by the direct injection system comprises at least one non-residual herbicide.

3. The system of claim 1, wherein the herbicidal mixture in the tank comprises at least one non-residual herbicide.

4. The system of claim 1, wherein the at least one sensor comprises a machine-learning-based weed detection device configured to distinguish target weeds from background crops and/or soil.

5. The system of claim 4, wherein the machine-learning-based weed detection device was trained using images that contain examples of target weeds and images that do not contain the target weeds.

6. The system of claim 1, wherein each coverage area is covered by exactly one first nozzle from the first valve system and exactly one second nozzle from the second valve system.

7. The system of claim 1, wherein the inconclusive indication is triggered by at least one of:
(i) a height of the first spray nozzles and/or a height of the second spray nozzles is/are outside of a respective predetermined height range for operation,
(ii) one or more environmental factors preventing accurate weed detection,
(iii) insufficient illumination conditions for the at least one sensor, and/or
(iv) a malfunction and/or a communication failure of the at least one sensor.

8. A method for spraying an agricultural field, comprising:
in a spray system that includes a spray boom attached to an agricultural vehicle, the spray boom including a plurality of image sensors, a plurality of first spray nozzles, and a plurality of second spray nozzles, the first spray nozzles fluidly coupled to a first fluid line that holds a first herbicide mixture that includes at least one residual herbicide, the second spray nozzles fluidly coupled to a second fluid line that holds a second herbicide mixture that includes the at least one residual herbicide and at least one non-residual herbicide, the first and second spray nozzles arranged in a plurality of nozzle groups, each nozzle group including at least one first spray nozzle and at least one second spray nozzle, the at least one first spray nozzle and the at least one second spray nozzle in a respective nozzle group having respective spray areas that are spatially aligned with one another, each nozzle group associated with a respective image sensor:
automatically capturing, with each image sensor, images of an agricultural field, each image sensor associated with a respective nozzle group;
automatically analyzing, with one or more computers, each image for a presence of at least one target weed;
automatically detecting, with the one or more computers, the at least one target weed in one or more image areas of one or more of the images to provide at least one weed-detected image having at least one weed-detected image area in which the at least one target weed is detected and at least one weed-absent image area in which the at least one target weed is not detected;
automatically exclusively spraying the first herbicide mixture onto one or more first regions of the agricultural field, each first region corresponding to a respective weed-absent image area;
automatically exclusively spraying the second herbicide mixture onto one or more second regions of the agricultural field, each second region corresponding to a respective weed-detected image area,
whereby the first herbicide mixture is only sprayed onto the one or more first regions and the second herbicide mixture is only sprayed onto the one or more second regions.

9. The method of claim 8, wherein:
each first region of the agricultural field is sprayed by a respective first spray nozzle having a respective first spray area spatially aligned with a respective first region, and
each second region of the agricultural field is sprayed by a respective second spray nozzle having a respective second spray area spatially aligned with a respective second region.

10. The method of claim 8, wherein:
the image sensors comprise cameras, and
the method further comprises:
automatically analyzing, with a respective trained machine learning (ML) model running on a respective computer, a respective image for the presence of the at least one target weed, the trained ML model having been trained with first images that include the at least one target weed and second images that do not include the at least one target weed; and
automatically detecting, with the respective trained ML model, the at least one target weed in the one or more image areas of the one or more of the images.

11. The method of claim 10, wherein:
each camera has a respective field of view (FOV) that is subdivided into a plurality of FOV regions, each FOV region associated with a respective first spray nozzle of the respective nozzle group and a respective second spray nozzle of the respective nozzle group,
each image area corresponds to a respective FOV area,
each first region of the agricultural field is sprayed by the respective first spray nozzle that corresponds to the respective FOV area for a respective weed-absent image area, and
each second region of the agricultural field is sprayed by the respective second spray nozzle that corresponds to the respective FOV area for a respective weed-detected image area.

12. A spray boom comprising:
a plurality of image sensors mounted on the spray boom, each image sensors configured to capture a respective image of a respective region of an agricultural field;
a plurality of first spray nozzles mounted on the spray boom, the first spray nozzles fluidly coupled to a first fluid line that holds a first herbicide mixture that includes at one residual herbicide;
a plurality of second spray nozzles mounted on the spray boom, the second spray nozzles fluidly coupled to a second fluid line that holds a second herbicide mixture that includes the at one residual herbicide and at least one non-residual herbicide, the first and second spray nozzles arranged in a plurality of nozzle groups, each nozzle group including at least one first spray nozzle and at least one second spray nozzle, the at least one first spray nozzle and the at least one second spray nozzle in a respective nozzle group having respective spray areas that are spatially aligned with one another, each nozzle group associated with a respective image sensor; and
one or more processors configured to:
automatically analyze each image for a presence of at least one target weed;
automatically detecting the at least one target weed in one or more image areas of one or more of the images to provide at least one weed-detected image having at least one weed-detected image area in which the at least one target weed is detected and at least one weed-absent image area in which the at least one target weed is not detected;
for each weed-absent image area of a respective weed-detected image, cause only a respective first spray nozzle to spray the first herbicidal mixture onto a respective first target area that corresponds to a respective weed-absent image area, the respective first nozzle in the respective nozzle group associated with the respective image sensor that captured the respective weed-detected image, such that each first target area is sprayed exclusively with the first herbicidal mixture; and
for each weed-detected image area of the respective weed-detected image, cause only a respective second spray nozzle to spray the second herbicidal mixture onto a respective second target area that corresponds to a respective weed-detected image area, the respective second nozzle in the respective nozzle group associated with the respective image sensor that captured the respective weed-detected image, such that each second target area is sprayed exclusively with the second herbicidal mixture.

13. The spray boom of claim 12, wherein:
the image sensors comprise cameras, and
the one or more processors is/are further configured to:
automatically analyze, with one or more trained machine learning (ML) models, each image for the presence of the at least one target weed, the trained ML model(s) having been trained with first images that include the at least one target weed and second images that do not include the at least one target weed; and
automatically detect, with the trained ML model(s), the at least one target weed in the one or more image areas of the one or more of the images.

14. The spray boom of claim 13, wherein:
each camera has a respective field of view (FOV) that is subdivided into a plurality of FOV regions, each FOV region associated with a respective first spray nozzle of the respective nozzle group and a respective second spray nozzle of the respective nozzle group,
each image area corresponds to a respective FOV area,
each first target area is sprayed by the respective first spray nozzle that corresponds to the respective FOV area for a respective weed-absent image area, and
each second target area is sprayed by the respective second spray nozzle that corresponds to the respective FOV area for a respective weed-detected image area.

15. The spray boom of claim 12, wherein
the at least one target weed is not detected in on or more images to provide at least one weed-absent image, each weed-absent image having a plurality of the weed-absent image areas, and
the one or more processors is/are further configured to, for each weed-absent image area of a respective weed-absent image, cause only the respective first spray nozzle to spray the first herbicidal mixture onto the respective first target area that corresponds to the respective weed-absent image area, the respective first nozzle in the respective nozzle group associated with the respective image sensor that captured the respective weed-detected image.

16. The spray boom of claim 12, further comprising:
a plurality of first valves fluidly coupled to the first fluid line, each first valve fluidly coupled to a respective first spray nozzle;
a plurality of second valves fluidly coupled to the second fluid line, each second valve fluidly coupled to a respective second spray nozzle,
wherein the one or more processors is/are further configured to:
for each weed-absent image area of the respective weed-detected image, cause only a respective first valve to open, the respective first valve fluidly coupled to the respective first spray nozzle that sprays the respective first target area that corresponds to the respective weed-absent image area, the respective first nozzle in the respective nozzle group associated with the respective image sensor that captured the respective weed-detected image; and
for each weed-detected image area of the respective weed-detected image, cause only a respective second valve to open, the respective second valve fluidly coupled to the respective second spray nozzle that sprays the respective second target area that corresponds to the respective weed-detected image area, the respective second nozzle in the respective nozzle group associated with the respective image sensor that captured the respective weed-detected image.

17. The spray boom of claim 16, wherein the one or more processors is/are further configured to:
for each weed-detected image area of the respective weed-detected image, cause the respective first valve to close, the respective first valve fluidly coupled to the respective first spray nozzle having a respective first target spray area that is spatially aligned with the respective second target area; and
for each weed-absent image area of the respective weed-detected image, cause the respective second valve to close, the respective second valve fluidly coupled to the respective second spray nozzle having a respective second target spray area that is spatially aligned with the respective first target area.

18. The spray boom of claim 12, wherein each nozzle group includes a plurality of nozzle pairs, each nozzle pair including only one respective first spray nozzle and only one respective second spray nozzle, the first and second spray nozzles in a respective nozzle pair having respective spray areas that are spatially aligned with one another.

19. The spray boom of claim 12, wherein each nozzle group includes a plurality of nozzle sub-groups, each nozzle sub-group including one or more of the respective first spray nozzles and one or more of the respective second spray nozzles, the one or more first spray nozzles and the one or more second spray nozzles in a respective nozzle sub-group having respective spray areas that are at least partially spatially aligned with one another.

20. The spray boom of claim 19, wherein each nozzle sub-group includes more of the respective second spray nozzles than the respective first spray nozzles.

21. An agricultural spray system comprising:
an agricultural vehicle;
the spray boom of claim 12, the spray boom attached to the agricultural vehicle;
a first tank on the agricultural vehicle, the first spray tank holding the first herbicide mixture, the first tank fluidly coupled to the first fluid line; and
a second tank on the agricultural vehicle, the second tank capable of holding the second herbicidal mixture, the second tank fluidly coupled to the second fluid line.

22. An agricultural spray system comprising:
an agricultural vehicle;
the spray boom of claim 12, the spray boom attached to the agricultural vehicle;
a residual herbicide tank on the agricultural vehicle, the residual herbicide tank holding the at least one residual herbicide, the residual herbicide tank fluidly coupled to the first fluid line;
a reservoir tank on the agricultural vehicle, the reservoir tank having a first input fluidly coupled to the residual herbicide tank to receive the at least one residual herbicide;
a container configured to hold the at least one non-residual herbicide, the container on the agricultural vehicle; and
a direct injection system fluidly coupled to the container and to a second input of the reservoir tank, the direct injection system configured to introduce the at least one non-residual herbicide into the reservoir tank to produce the second herbicidal mixture, the reservoir tank having an output fluidly coupled to the second fluid line.

23. An agricultural spray system comprising:
an agricultural vehicle;
the spray boom of claim 12, the spray boom attached to the agricultural vehicle;
a water tank on the agricultural vehicle;
a first container configured to hold the at least one residual herbicide, the first container on the agricultural vehicle;
a second container configured to hold the at least one non-residual herbicide, the second container on the agricultural vehicle;
a first reservoir tank on the agricultural vehicle, the first reservoir tank having a first input fluidly coupled to the water tank and a first output fluidly coupled to the first fluid line;
a second reservoir tank on the agricultural vehicle, the second reservoir tank having a first input fluidly coupled to the water tank, a second input fluidly coupled to a second output of the first reservoir tank, and an output fluidly coupled to the second fluid line;
a first direct injection system having a first input fluidly coupled to the first container and an output fluidly coupled to a second input of the first reservoir tank, the first direct injection system configured to introduce the at least one residual herbicide into the first reservoir tank to produce the first residual herbicide mixture; and
a second direct injection system having a first input fluidly coupled to the second container and an output fluidly coupled to a third input of the second reservoir tank, the second direct injection system configured to introduce the at least one non-residual herbicide into the second reservoir tank to form the second herbicidal mixture that comprises the first residual herbicide mixture and the least one non-residual herbicide.

24. An agricultural spray system comprising:
an agricultural vehicle;
the spray boom of claim 12, the spray boom attached to the agricultural vehicle;
a water tank on the agricultural vehicle;
a first container configured to hold the at least one residual herbicide, the first container on the agricultural vehicle;
a second container configured to hold the at least one non-residual herbicide, the second container on the agricultural vehicle;
a first reservoir tank on the agricultural vehicle and having a first input fluidly coupled to the water tank and a first output fluidly coupled to the first fluid line;
a second reservoir tank on the agricultural vehicle, the second reservoir tank having a first input fluidly coupled to a second output of the first reservoir tank and an output fluidly coupled to the second fluid line;
a first direct injection system having a first input fluidly coupled to the first container and an output fluidly coupled to a second input of the first reservoir tank, the first direct injection system configured to introduce the at least one residual herbicide into the reservoir tank to produce the first herbicide mixture; and
a second direct injection system having a first input fluidly coupled to the second container and an output fluidly coupled to a third input of the second reservoir tank, the second direct injection system configured to introduce the at least one non-residual herbicide into the second reservoir tank to form the second herbicidal mixture that comprises the first herbicide mixture and the at least one non-residual herbicide.

25. An agricultural spray system comprising:
an agricultural vehicle;
the spray boom of claim 12, the spray boom attached to the agricultural vehicle;
a water tank on the agricultural vehicle;
a first container configured to hold the at least one residual herbicide, the first container on the agricultural vehicle;
a second container configured to hold the at least one residual herbicide and the at least one non-residual herbicide, the second container on the agricultural vehicle;
a first reservoir tank on the agricultural vehicle and having a first input fluidly coupled to the water tank and an output fluidly coupled to the first fluid line;
a second reservoir tank on the agricultural vehicle, the second reservoir tank having a first input fluidly coupled to the water tank and an output fluidly coupled to the second fluid line;
a first direct injection system having a first input fluidly coupled to the first container and an output fluidly coupled to a second input of the first reservoir tank, the first direct injection system configured to introduce the at least one residual herbicide into the reservoir tank to produce the first herbicide mixture; and
a second direct injection system having a first input fluidly coupled to the second container and an output fluidly coupled to a second input of the second reservoir tank, the second direct injection system configured to introduce the at least one residual herbicide and the at least one non-residual herbicide into the second reservoir tank to form the second herbicidal mixture.

26. An agricultural spray system comprising:
an agricultural vehicle;
a spray boom attached to the agricultural vehicle;
a plurality of cameras mounted on the spray boom, each camera configured to capture a respective image of a respective region of an agricultural field;
a plurality of broadcast nozzles mounted on the spray boom, the broadcast nozzles fluidly coupled to a broadcast fluid line;
a plurality of selective-spot spray (SSP) nozzles mounted on the spray boom, the SSP nozzles fluidly coupled to an SSP fluid line;
a water tank on the agricultural vehicle;
one or more first containers, each first container configured to hold a respective residual herbicide, each first container on the agricultural vehicle;
one or more second containers, each second container configured to hold a respective non-residual herbicide, each second container on the agricultural vehicle;
a first fluid line fluidly coupled to the water tank;
a second fluid line fluidly coupled to the water tank;
one or more first direct injection systems, each first direct injection system having a respective first input fluidly coupled to a respective first container and a respective output fluidly coupled to the first fluid line, each first direct injection system configured to introduce the respective residual herbicide into the first fluid line;
one or more second direct injection systems, each second direct injection system having a respective first input fluidly coupled to a respective second container and a respective output fluidly coupled to the second fluid line, each second direct injection system configured to introduce the respective residual herbicide into the second fluid line;
a first in-line mixer fluidly coupled to the first fluid line and configured to mix each residual herbicide and water from the water tank to form a residual herbicide mixture;
a second in-line mixer fluidly coupled to the second fluid line and configured to mix each non-residual herbicide and the water to form a non-residual herbicide mixture; and
a mixing tank configured to hold a volume of the non-residual herbicide mixture, the mixing tank having an input fluidly coupled to an output of the second mixing tank, the mixing tank having an output fluidly coupled to the SSP nozzles.

27. The agricultural spray system of claim 26, further comprising
one or more processors configured to:
automatically analyze, with a trained machine learning (ML) model, each image for a presence of at least one target weed, the trained ML model having been trained with first images that include the at least one target weed and second images that do not include the at least one target weed;
automatically detect, with the trained ML model, the at least one target weed in one or more image areas of one or more of the images to provide at least one weed-detected image having at least one weed-detected image area in which the at least one target weed is detected and at least one weed-absent image area in which the at least one target weed is not detected;
for each weed-detected image area of a respective weed-detected image, automatically cause a respective SSP nozzle to selectively spot spray the non-residual herbicide mixture onto a respective first target area that corresponds to a respective weed-detected image area; and
automatically cause the broadcast nozzles to broadcast spray the residual herbicide mixture substantially continuously onto the agricultural field.

28. An agricultural spray system comprising:
an agricultural vehicle;
a water tank on the agricultural vehicle;
a first fluid line fluidly coupled to the water tank;
a second fluid line fluidly coupled to the water tank;
a first direct injection system fluidly coupled to at least one container configured to hold a first herbicide, the first direct injection system configured to introduce the first herbicide into the first fluid line;
a second direct injection system fluidly coupled to at least one container configured to hold a second herbicide, the second direct injection system configured to introduce the second herbicide into the second fluid line;
at least one sensor mounted on the agricultural vehicle and configured to detect a presence or absence of weeds in a particular area of a field; and
at least one valve operably connected to the at least one sensor, the at least one sensor being configured to send a command to the at least one valve to selectively spray or not spray the particular area using the first fluid line and/or the second fluid line.

29. The agricultural spray system of claim 28, wherein the first herbicide comprises at least one residual herbicide and the second herbicide comprises at least one non-residual herbicide.

30. The agricultural spray system of claim 28, wherein one of the fluid lines is configured to spray in a broadcast mode, and the other fluid line is configured to refrain from spraying in areas where no weeds are detected.

31. The agricultural spray system of claim 29, wherein:
the first fluid line containing the at least one residual herbicide is configured to spray in a broadcast mode; and
the second fluid line containing the at least one non-residual herbicide is configured to spray upon detection of at least one of the weeds in the particular area of the field or upon occurrence of at least one of the following conditions:
(i) a height of the at least one valve is/are outside of a respective predetermined height range for operation,
(ii) one or more environmental factors prevent accurate weed detection,
(iii) insufficient illumination conditions for the at least one sensor, and/or
(iv) a malfunction and/or a communication failure of the at least one sensor.

32. The agricultural spray system of claim 28, further comprising a buffer tank having an input fluidly coupled to the second fluid line, the buffer tank configured to hold a volume of an herbicide mixture that includes water and the second herbicide, the buffer tank having an output fluidly coupled to the at least one valve, such that the at least one valve can selectively spray using the second fluid line when a flow rate of the second fluid line is variable.
